(19) United States
(12) Patent Application Publication
(10) Pub. No.: US 2007/0168523 A1
(43) Pub. Date: Jul. 19, 2007

(54) Multicast-unicast adapter

(75) Inventors: Hong Jiang, Westfield, NJ (US); Peter Andrew Mataga, Sparta, NJ (US); Edgar Villanueva, Rockaway, NJ (US)

Correspondence Address: BINGHAM MCCUTCHEN LLP, 2020 K Street, N.W., Intellectual Property Department, WASHINGTON, DC, 20006, US

(73) Assignee: Roundbox, Inc.

(21) Appl. No.: 11/318,528

(22) Filed: Dec. 28, 2005

Related U.S. Application Data
(60) Provisional application No. 60/669,915, filed on Apr. 11, 2005.

(51) Int. Cl. G06F 15/16

(52) U.S. Cl. 709/228

(57) ABSTRACT

A method and system provides the capability for multicast data traffic to flow with a unicast mechanism; that is, for some network entity to send a copy of the MC data session to a specific network address associated with the client. A method of transmitting data traffic comprises transmitting data using a multicast session to a plurality of destinations, determining that the multicast session to at least one of the destinations of the plurality of destinations should be switched to a unicast session to the at least one destination, and switching the multicast session to the at least one destination to a unicast session to the at least one destination.

### CROSS-REFERENCE TO RELATED APPLICATIONS

The benefit, under 35 U.S.C. §119(e), of Provisional Application No. 60/669,915, filed Apr. 11, 2005, is hereby claimed.

### TECHNICAL FIELD

The present technology relates to a method, system, and computer program for providing the capability for software applications that are designed to operate in a multicast environment to continue to operate when multicast routing of data packets is not available or not optimal.

### BACKGROUND OF THE TECHNOLOGY

There are many network applications that can advantageously make use of broadcast, multicast, or other one-to-many mechanisms for routing of data packets (generically referred to as MC). Examples include broadcast streaming media, large-scale multicast conferences, emergency notification services, and file/content distribution. Multicast allows these applications to massively scale in such a way that adding data recipients does not require significant incremental network resources.

In such applications, the data stream source is able to send the data packets to a MC destination address rather than to a specific (unicast) destination address. When the appropriate MC routing is available in the network, client applications may join the MC “session”—that is, listen to their own copy of the data stream—if they know the “session identifier”; this occurs without direct interaction with the data source. For example, IP multicast requires the multicast address to establish the routing in the underlying network, and the associated port to listen to a specific data flow. A second example is 3GPP2 Wireless broadcast/multicast, where a FLOW_ID is required to identify the unidirectional data stream, and a set of technology-specific protocols are used to establish the multicast.

If a multicast data session is always available for the client to receive, listening to such a session is likely to be optimal for both client and network resource usage. However, it may happen that the MC mechanism the client is expecting to employ is not available. This may occur, for example, because
MC is not supported by the network at all;
MC is supported at the data source, but not supported locally because of the local network type;
the client or user is not currently authorized to employ MC; or
the local network has a simultaneous user threshold for MC usage that has not been reached.

A need arises for a technique by which multicast data traffic can still flow even when a multicast mechanism is not available.

### SUMMARY OF THE TECHNOLOGY

The present invention provides the capability for multicast data traffic to flow with a unicast mechanism; that is, for some network entity to send a copy of the MC data session to a specific network address associated with the client. The transport mechanism for this data may be any one of a variety of connection-oriented or connectionless protocols, depending on the type of network and data involved. Examples for IP-capable networks include TCP and RTP over UDP. Some suitable application-level protocols may also be used to establish the data session (examples include HTTP, SIP, and RTSP).

In one embodiment of the present invention, a method of transmitting data traffic comprises transmitting data using a multicast session to a plurality of destinations, determining that the multicast session to at least one of the destinations of the plurality of destinations should be switched to a unicast session to the at least one destination, and switching the multicast session to the at least one destination to a unicast session to the at least one destination.

In one aspect of the present invention, the determination that the multicast session to the at least one destination should be switched to a unicast session to the at least one destination is based on a quality of service of the multicast session. The determination that the multicast session to the at least one destination should be switched to a unicast session to the at least one destination comprises determining that the quality of service of the multicast session to the at least one destination has fallen below a threshold.

In one aspect of the present invention, the determination that the multicast session to the at least one destination should be switched to a unicast session to the at least one destination is based on an availability of the multicast session.

In one aspect of the present invention, the determination that the multicast session to the at least one destination should be switched to a unicast session to the at least one destination is based on a number of destinations of the multicast session.

In one aspect of the present invention, the determination that the multicast session to the at least one destination should be switched to a unicast session to the at least one destination is based on net network resource savings if the multicast session were switched to the unicast session.

In one aspect of the present invention, the method of further comprises determining that the unicast session to the at least one destination should be switched to the multicast session to the plurality of destinations and switching the unicast session to the at least one destination to the multicast session to the plurality of destinations.

In one aspect of the present invention, the determination that the unicast session to the at least one destination should be switched to the multicast session to the plurality of destinations is based on a quality of service of the multicast session. The determination that the unicast session to the at least one destination should be switched to the multicast session to the plurality of destinations comprises determining that the quality of service of the multicast session has risen above a threshold.

In one aspect of the present invention, the determination that the unicast session to the at least one destination should be switched to the multicast session to the plurality of destinations is based on an availability of the multicast session.

In one aspect of the present invention, the determination that the unicast session to the at least one destination should be switched to the multicast session to the plurality of destinations is based on a number of destinations of the multicast session.

In one aspect of the present invention, the determination that the unicast session to the at least one destination should be switched to the multicast session to the plurality of destinations is based on net network resource savings if the unicast session were switched to the multicast session

In one aspect of the present invention, switching the multicast session to a unicast session comprises initiating the unicast session to the at least one destination before ending the multicast session to the at least one destination, transmitting data to the at least one destination using both the multicast session and the unicast session, and ending the multicast session. The transmitting of data to the at least one destination using both the multicast session and the unicast session comprises combining the data from the multicast session with the data from the unicast session.

In one aspect of the present invention, switching the unicast session to a multicast session comprises initiating the multicast session to the at least one destination before ending the unicast session to the at least one destination, transmitting data to the at least one destination using both the multicast session and the unicast session, and ending the unicast session. The transmitting of data to the at least one destination using both the multicast session and the unicast session comprises combining the data from the multicast session with the data from the unicast session.

In one embodiment of the present invention, a system for transmitting data traffic from a data source to a client application comprises a server adapter operable to receive data from the data source in a unicast session and transmit the data in a unicast session or in a multicast session, and operable to receive data from the data source in a multicast session and transmit the data in at least one unicast session or in a multicast session, and a client adapter operable to receive data from the server adapter in a unicast session or a multicast session and transmit the data to the client application.

In one aspect of the present invention, the server adapter is further operable to switch between transmitting the data in a unicast session or in a multicast session. The server adapter is further operable to determine that the multicast session should be switched to at least one unicast session and to switch the multicast session to the at least one unicast session.

In one aspect of the present invention, the server adapter is further operable to determine that the multicast session should be switched to at least one unicast session based on a quality of service of the multicast session.

In one aspect of the present invention, server adapter is further operable to determine that the multicast session should be switched to at least one unicast session by determining that the quality of service of the multicast session to the at least one destination has fallen below a threshold.

In one aspect of the present invention, the server adapter is further operable to determine that the multicast session should be switched to at least one unicast session based on an availability of the multicast session.

In one aspect of the present invention, the server adapter is further operable to determine that the multicast session should be switched to at least one unicast session based on a number of destinations of the multicast session.

In one aspect of the present invention, the server adapter is further operable to determine that the multicast session should be switched to at least one unicast session based on net network resource savings if the multicast session were switched to the unicast session.

In one aspect of the present invention, the server adapter is further operable to determine that the at least one unicast session should be switched to a multicast session and to switch the at least one unicast session to a multicast session.

In one aspect of the present invention, the server adapter is further operable to determine that the at least one unicast session should be switched to a multicast session based on a quality of service of the multicast session.

In one aspect of the present invention, the server adapter is further operable to determine that the at least one unicast session should be switched to a multicast session by determining that the quality of service of the multicast session to the at least one destination has fallen below a threshold.

In one aspect of the present invention, the server adapter is further operable to determine that the at least one unicast session should be switched to a multicast session based on an availability of the multicast session.

In one aspect of the present invention, the server adapter is further operable to determine that the at least one unicast session should be switched to a multicast session based on a number of destinations of the multicast session.

In one aspect of the present invention, the server adapter is further operable to determine that the at least one unicast session should be switched to a multicast session based on net network resource savings if the unicast session were switched to the multicast session.

In one aspect of the present invention, the server adapter is further operable to switch the multicast session to a unicast session by initiating the unicast session before ending the multicast session, transmitting data using both the multicast session and the unicast session, and ending the multicast session. The client adapter is further operable to receive data from the server adapter in both a unicast session and a multicast session and transmit the data to the client application. The client adapter is further operable to receive data from the server adapter in both a unicast session and a multicast session by combining the data from the multicast session with the data from the unicast session.

In one aspect of the present invention, the server adapter is further operable to switch the unicast session to a multicast session by initiating the multicast session before ending the unicast session, transmitting data using both the multicast session and the unicast session, ending the unicast session. The client adapter is further operable to receive data from the server adapter in both a unicast session and a multicast session and transmit the data to the client application. The client adapter is further operable to receive data from the server adapter in both a unicast session and a multicast session by combining the data from the multicast session with the data from the unicast session.

### BRIEF DESCRIPTION OF THE DRAWINGS

Objects and advantages of the technology described in the present disclosure will be more clearly understood when considered in conjunction with the accompanying drawings, in which:

FIG. 1 is an exemplary block diagram of a system in which the present invention may be implemented.

FIG. 2 is an exemplary block diagram of a system in which the present invention may be implemented.

FIG. 3 is an exemplary flow diagram of a multicast/unicast transmission process.

FIG. 4 is an exemplary block diagram of a broadcast/multicast (BCMCS) architecture with multicast/unicast enhancement.

FIG. 5 is an exemplary message flow diagram of the message flow in a baseline multicast scenario.

FIG. 6 is an exemplary message flow diagram of the message flow in a multicast/unicast message flow scenario.

FIG. 7 is an exemplary block diagram of a system in which the present invention may be implemented, which includes multi-network adaptation.

FIG. 8 is an exemplary block diagram of a system in which the present invention may be implemented having a centralized SA cluster and a plurality of networks having multicast routing capability.

FIG. 9 is an exemplary block diagram of a system in which the present invention may be implemented having distributed (hub-and-spoke) implementation of a Multicast-Unicast Server Adapter architecture.

FIG. 10 is an exemplary block diagram of a system in which the present invention may be implemented having application level soft combine.

FIG. 11 is an exemplary flow diagram of a basic multicast/unicast switching scenario.

FIG. 12 is an exemplary block diagram of a system in which the present invention may be implemented showing the cell structure of the MC network.

FIG. 13 is an exemplary data flow diagram of a system in which the present invention may be implemented showing simple handoff scenario.

FIG. 14 is an exemplary flow diagram of a process for performing a handoff in the system shown in FIG. 13.

FIG. 15 is an exemplary data flow diagram of a system in which the present invention may be implemented showing soft handoff scenario.

FIG. 16 is an exemplary flow diagram of a process for performing a soft handoff in the system shown in FIG. 15.

FIG. 17 is an exemplary flow diagram of a process of unicast to multicast switching based on dynamic resource optimization.

FIG. 18 is an exemplary flow diagram of a process of multicast to unicast switching based on dynamic resource optimization.

FIG. 19 is an exemplary message flow diagram of the message flow in a multicast to unicast to multicast switching scenario.

FIG. 20 is an exemplary message flow diagram of the message flow in a multicast to unicast to multicast switching scenario.

FIG. 21 is an exemplary message flow diagram of the message flow in a multicast to unicast to multicast switching scenario.

FIG. 22 is an exemplary flow diagram of a threshold-based switching policy.

FIG. 23 is an exemplary block diagram of a network cell topology.

FIG. 24 is an exemplary flow diagram of a switching optimization process.

FIG. 25 is an exemplary flow diagram of a channel/session switching process.

### DETAILED DESCRIPTION

The present invention provides the capability for multicast data traffic to flow with a unicast mechanism; that is, for some network entity to send a copy of the MC data session to a specific network address associated with the client. The transport mechanism for this data may be any one of a variety of connection-oriented or connectionless protocols, depending on the type of network and data involved. Examples for IP-capable networks include TCP and RTP over UDP. Some suitable application-level protocols may also be used to establish the data session (examples include HTTP, SIP, and RTSP).

Ideally, this ought to happen without involving the data source itself. To enable this requires cooperation between two components, one on the client side, and one the server side. This invention consists of these two components, which are referred to as the Multicast-Unicast Server Adapter (SA) and Multicast-Unicast Client Adapter (CA).

It is also possible that the delivery mechanism for multicast data is a physically separate network from the network that supports unicast and point-to-point data interactions. For example, data streams might be broadcast using a satellite infrastructure, but the client applications have a cellular data connection as well. One of the functions of the adaptation is to provide a uniform interface to applications regardless of the network that is being used at that instant to receive packet data. In particular, that the SA and CA functions may in fact be distributed physically. For example, an SA may have a signaling component that resides on one network host and a media processing/routing component that resides on another.

Adaptation may also be required on the data source side, if the SA is not also the data source. In some networks, it may not be possible for the data source to send to a multicast address directly. For example, security information may be required that is accessible only to certain network components and not to generic applications; in this case the security-aware application must be the multicast source. This is the case for 3G Wireless Broadcast/Multicast Services, for example.

Under these circumstances, the data session must flow as a unicast stream (or as a multicast stream that does not extend to the client side) to some entity that manipulates the stream and redistributes it as a multicast stream accessible to clients. This is not in itself novel, but we describe some novel ways that this function is used in combination with multicast-to-unicast adaptation, and in media-push types of application.

There are a number of exemplary realizations of the MC mechanism. For example, in an IP multicast realization, the MC mechanism is end-to-end IP multicast, but not all of the network is multicast-enabled. The client-side adapter (CA) attempts to perform a multicast join to the address required, but the join fails. It then communicates with the server-side adapter (SA), which is listening to the multicast (in this case), to establish an IP unicast session.

This case includes networks with wired connectivity (layer 2 multicast mechanism is Ethernet, for example) and those with wireless last hops that support end-to-end IP multicasting (WiFi or WiMAX, for example).

In an example of a 3G Wireless Broadcast/Multicast realization, the MC mechanism used locally by the client is a radio network broadcast/multicast mechanism such as BCMCS or MBMS, each of which reuses the corresponding point-to-point data mechanism for broadcasting data packets. The CA uses the MC session information (IP multicast address:port or FLOW_ID), but the sector in which the client is currently located does not support (or refuses to establish) the multicast flow. The CA and SA establish an IP unicast over the point-to-point wireless data infrastructure.

On the server side, an application that generates a session will not in general be able to multicast it (the application does not have access to the required key and network topology information). Rather, it must establish a unicast session to the SA (which plays the role of a BCMCS Controller and Content Server or MBMS BM-SC), using point-to-point data interaction (via CDMA2000 1xEV-DO or GSM UMTS, for example).

The BCMCS example will be used as a specific example throughout this description as description of a preferred implementation.

In an example of a Mobile Broadcasting realization, the MC mechanism used locally by the client is a one-way (“forward link only”) radio network broadcast mechanism such as the Digital Video Broadcasting (DVB) Transmission System for Handheld Terminals (DVB-H) or the QUALCOMM MediaFLO® system. The client is also capable of point-to-point wireless data interactions. (Note that this will normally be the case for such applications because of the need for authorization, key exchange, and unrelated application-level data interactions.) This allows an adaptation very similar to the 3G broadcast/multicast case, even though the multicast and unicast data network paths are distinct in this case.

Examples of applications of the present invention include but are not limited to the following types of application.

For example, the present invention may be advantageously used in a Streaming Media application. A wide range of applications involve streaming video and audio media. The packet streams in this case are used as input to a streaming media player that displays the media to the user, records the media on the client device, and so on. The source for the media can be live broadcast content or stored media.

As another example, the present invention may be advantageously used in a Content Distribution application. Content Distribution involves a class of applications that use the data session to distribute content in the form of data files. In this case the broadcast stream consists of packets that are assembled to reconstruct the data file on the client, typically in the form of a data carousel employing a transport mechanism such as File Delivery over Unidirectional Transport (FLUTE).

As another example, the present invention may be advantageously used in a Multicast Push-To-X Application. In a certain class of one-to-many media application, referred to here as “Push-To-X” applications, an application initiates a session in real time by sending an announcement to selected clients, using a point-to-point, multicast, or broadcast mechanism. Each client so notified may elect to join the session and listen to a common media session. (There may also be other interactions within the session that are not of a MC nature.)

Existing Push-To-X applications such as Push-To-Talk-Over-Cellular [16] are typically implemented by establishing multiple point-to-point sessions, in which unicast media sessions are employed. Server- and client-side interaction with the MCUC components allows the downstream media to be multicast or some combination of multicast and unicast.

The benefits of the MCUC adaptation fall into three categories: heterogeneous networks, reliability, and dynamic resource management.

A data network may provide a geographically heterogeneous level of multicast service. In particular, some parts of the network may support broadcast/multicast, while other parts may not. The MCUC adaptation can be used to provide applications with the appearance of multicast even in unicast-only regions. Enhancements for mobility can provide this benefit even under circumstances when a client moves between regions during a session.

The same advantages can derive under nominally homogeneous service circumstances, where the multicast varies in quality over time or as a client moves through a multicast region. Overlay of the multicast and unicast copies of a session can be used to provide improved QoS, including in some cases the possibility of taking advantage of decreased latency in reception of a data session.

A related but slightly different usage applies when multicast/unicast switching is indirectly or directly controlled by the network. In this case, the motivation is to allow the dynamic allocation of multicast and point-to-point data network resources, since multicast may be less efficient than one or more dedicated unicast sessions.

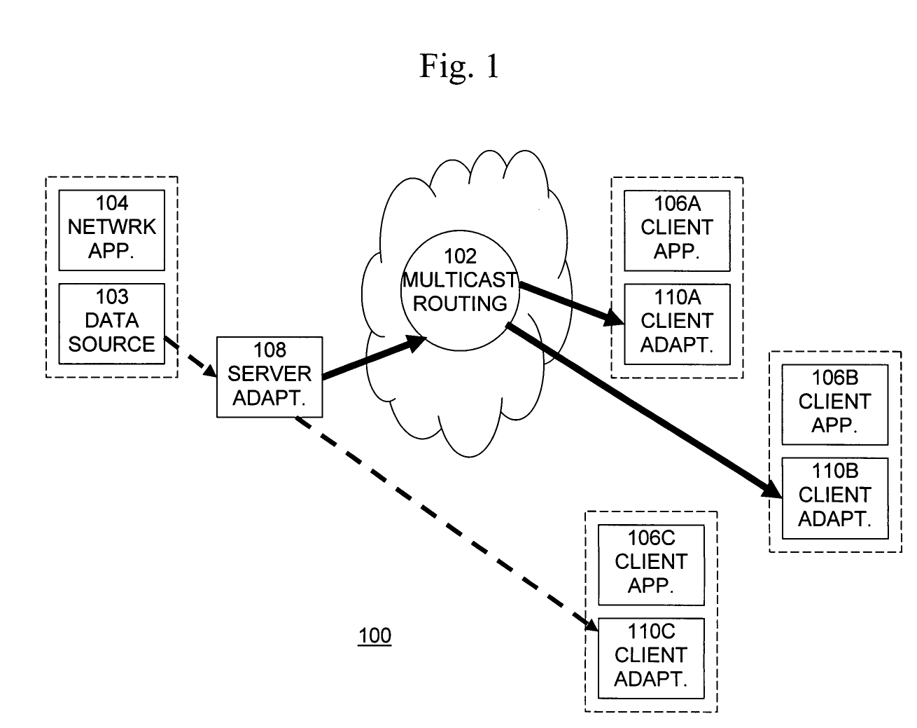

An example of a system 100 in which the present invention may be implemented is shown in FIG. 1. System 100 includes network 102 having multicast routing capability, Data Source (DS) 103, Network Application (NApp) 104, Client Applications (CApp) 106A-C, Multicast/Unicast (MCUC) Server Adapter (SA) 108, and MCUC Client Adapters (CA) 110A-C. Data Source (DS) 103 is the generator of the data packet stream (at least from the perspective of the MCUC components). This stream may be sent to a multicast address or to a unicast address associated with the SA 108. Network Application (NApp) 104 is associated with the data source 103, and may be responsible for communicating the MC session information to the client application. A Client Application (CApp), such as CApps 106A-C, is associated with each listening client, and attempts to join the MC session by interacting with its associated CA 110A-C. A MCUC CA 110A-C is responsible for transparently managing the MC join on behalf of the associated CApp 106A-C, establishing an alternative unicast session if necessary. It is typically instantiated as a network adapter layer underneath the client application software. The MCUC SA 108 is responsible for accepting requests from CAs for unicast session attachment, and multi-unicasting to the appropriate addresses. It must itself be the recipient of the data session (or a copy of it).

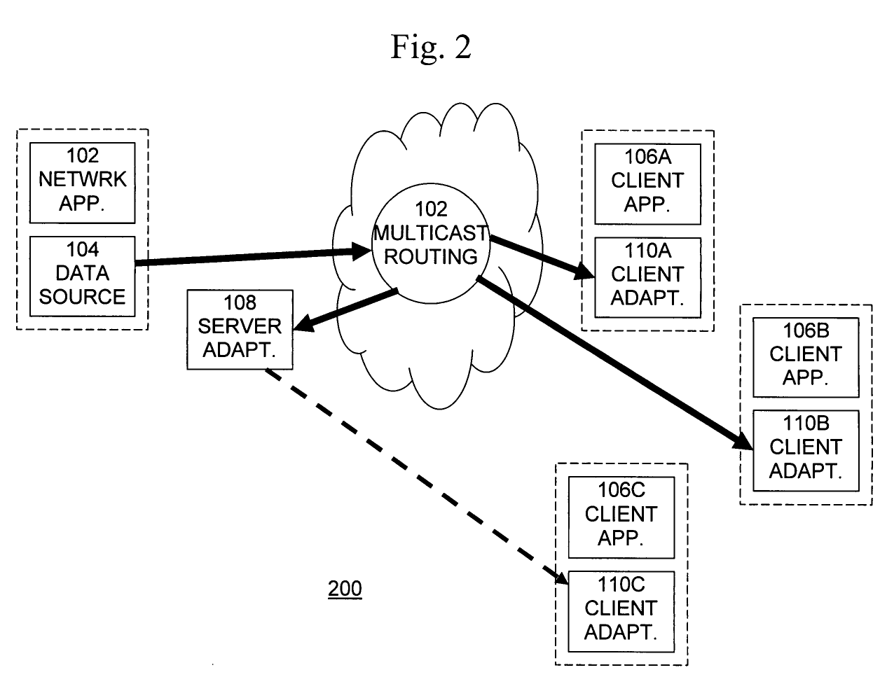

The MCUC SA may either listen to a dedicated unicast session from the DS (as shown in FIG. 1), or to an existing multicast session generated by the DS (as shown in the alternative arrangement in FIG. 2). In either case, it may also be responsible for copying the session to one or more multicast destinations—that is, it may be the multicast data source for clients. It is also possible, as discussed later, that a more complex network of elements is involved between the DS and the SA, and/or that there is more than one SA. Finally, it is possible that the SA is itself the content source; in this case the multicast and multi-unicast sessions are directly generated by the SA.

It is to be noted that although most of the descriptions here are phrased in terms of a single media stream, the MCUC adapters may perform setup and teardown of MC and UC sessions that involve multiple streams.

When the appropriate MC mechanism is enabled end-to-end for the client, the interactions between these components are the usual MC ones: the CA succeeds in joining the multicast that the CApp is requesting. This may or may not involve the SA, depending on whether the SA is the MC source or is merely a listener.

When the appropriate MC mechanism is not enabled end-to-end for the client, the CA discovers this fact or handles the failure to join, and communicates with the SA to establish an alternate unicast session that is a copy of the MC session. This failover occurs transparently (as much as is possible for the networking infrastructure and APIs in use) from the point of view of the CApp.

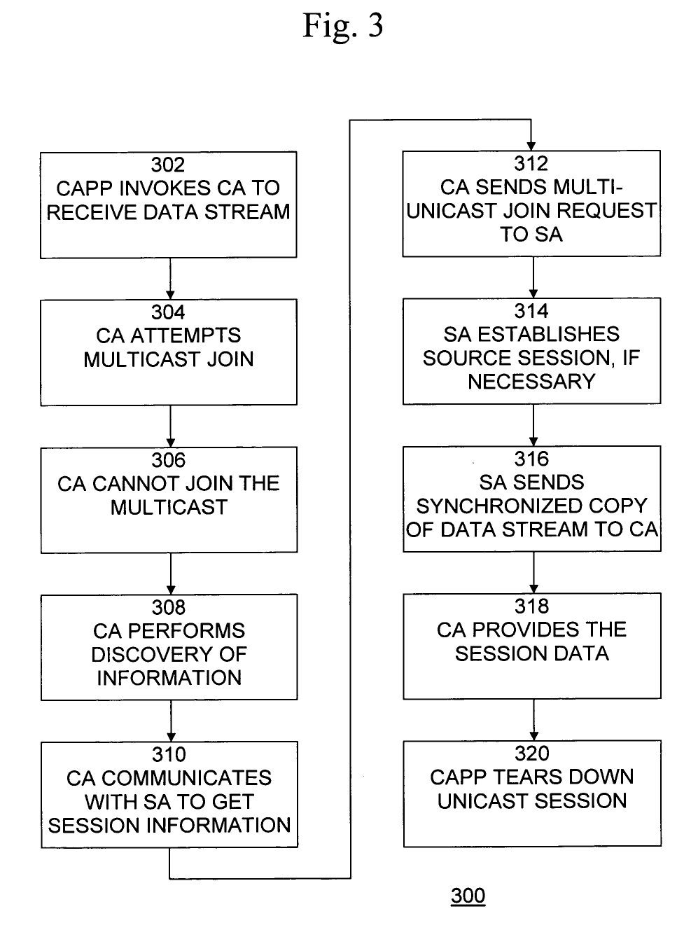

An example of a multicast/unicast transmission process 300, according to the present invention, is shown in FIG. 3. Process 300 is applicable whether or not there are existing multicast or unicast clients. However, the presence of other clients may affect the details, as they may have caused some actions already to have been taken by the SA and/or multicast infrastructure.

Process 300 begins operation after the session has been provisioned in such a way that all necessary network elements are aware of the session parameters. Some client CApp, having previously learned the session identifier (e.g., multicast IP address and port), needs to join the multicast. Then, process 300 begins with step 302, in which the CApp invokes its CA to receive the data stream for the MC session. In step 304, the CA attempts a multicast join appropriate to the MC technology in use. This procedure may involve multiple interactions, depending on how the specific MC infrastructure operates. It is possible that the CA need not interact explicitly with the SA in order to join the multicast, but the SA may be involved in MC join authorization for reasons discussed later.

In step 306, it is determined that, in this case, the CA cannot join the multicast. This may occur for a variety of reasons, as discussed above. In step 308, the CA performs any discovery necessary to obtain the information needed to communicate with the SA (for example, discovering the IP address of the nearest SA). In some cases, the CA will already have obtained this information, while in other cases, the information must be dynamically obtained.

In step 310, the CA communicates with the SA to learn any session information needed to set up a unicast session. (For example, a decryption key might be needed.) The CA may have previously obtained this information (possibly because some of the information is required for processing the MC session as well) or else the information is obtained dynamically.

In step 312, the CA sends a multi-unicast join request to the SA, typically informing the SA of its unicast destination information (a client's IP address and port, for example). The request succeeds. (Note that this might be combined with the previous interaction in some cases. It is also possible that the SA is already aware of the unicast address of the CA, e.g., a persistent connection is being used for media transmission.)

In step 314, the SA establishes its source session, if necessary. This will only be necessary if the SA has no other clients (including MC clients), though even in these circumstances the session from the DS may already be established to the SA. A variety of mechanisms are possible to establish the unicast inbound session to the SA: configuration of source and SA, SIP INVITE from the NApp, RTSP setup from SA to source, and so on. It is also possible that the SA is integrated with the DS, if it is a repository of stored content and responsible for encoding the session.

In step 316, the SA sends a synchronized copy of the data stream to the CA, using a unicast mechanism. This may be done ether immediately or on a specific subsequent request from the CA. In a case without transcoding, this means that for each incoming data packet, the SA sends to each unicast client and to any multicast addresses for which it is the source an outbound packet (or chunk within a connection-oriented unicast stream) with the same payload. In general, the encapsulation of the payload may be modified. It is also possible that the SA is providing transcoding or other media manipulation services, in which case the outbound packets may differ in number and content from the source. Nevertheless, the SA performs the one-to-many function.

In step 318, The CA provides the data session to the application in some suitable form (e.g., writes the packet payloads into an internal data buffer). The CApp can process this data without being aware of MC failure.

At some later time, CApp no longer needs the session. When the application stops listening, in step 320, the CA performs any interactions with the SA necessary to tear down the unicast session. This may lead the SA to perform teardown of its source session (or to leave the multicast from which it is receiving the session), in the case that there are no remaining clients, and no downstream multicast that needs to be supported.

MCUC adaptation may be applied to a number of environments and architectures. The simplest application of MCUC adaptation is to a network that is heterogeneous in its availability of multicast transport. A client may request service from a particular point in the network, and depending on the (static) availability of true MC, the CA transparently chooses the appropriate delivery mechanism. This simple case does not take into account dynamic aspects during a session such as mobility or local changes in multicast quality or availability, which are discussed below.

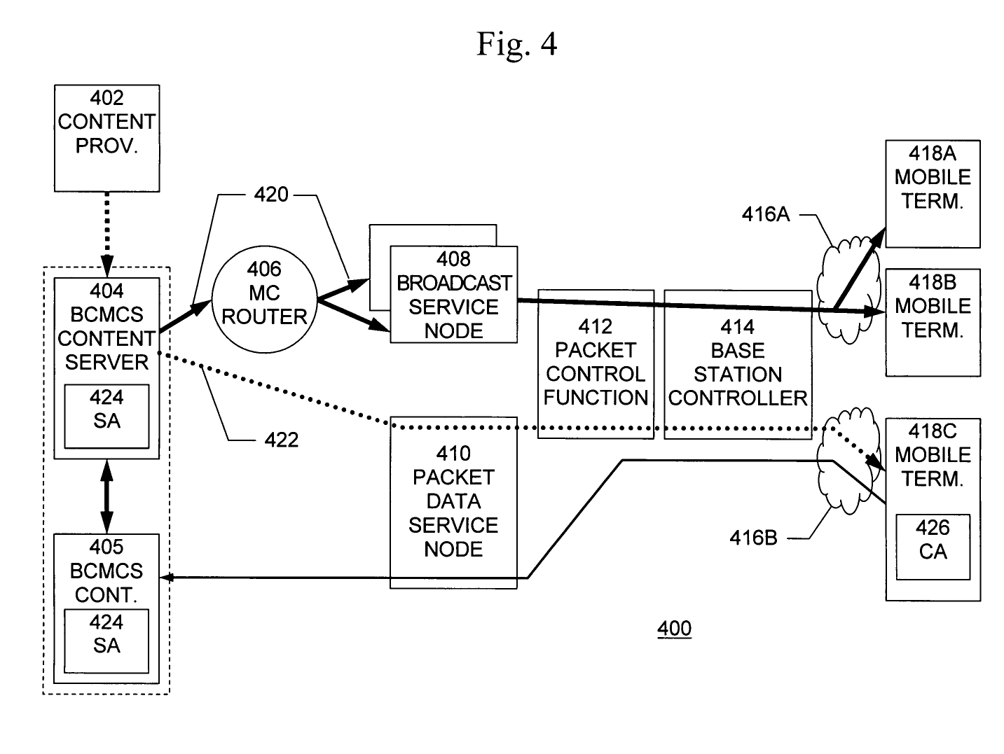

An example of a broadcast/multicast (BCMCS) architecture with multicast/unicast enhancement 400 is shown in FIG. 4. This architecture will be described with respect to a concrete message sequence for the exemplary case of BCMCS multicast technology. This example further assumes the SA is listening to a unicast inbound session, and is also responsible for generating the MC session. Architecture 400 includes content provider 402, BCMCS content server 404, BCMCS controller 405, multicast router 406, broadcast service nodes 408, packet data service node 410, packet control function 412, base station controller 414, mobile networks 416A-B, and mobile terminals 416A-C.

In a standard 3GPP2 BCMCS architecture, a BCMCS data stream 418 originates at a BCMCS content server 404 and is routed via a MC router 406. A Broadcast Service Node (BSN) 408 is added to the normal CDMA (1xEV-DO) packet data elements of the data stream. The Packet Control Function (PCF) 412 and Base Station Controller (BSC) 414, which will be referred to collectively as the Radio Network Controller (RNC), provide broadcast data functions in addition to the point-to-point data functions of a CDMA2000 network. The Packet Data Service Node (PDSN) 410 continues to perform its point-to-point data functions. These elements interact with a BCMCS Controller 405 and BCMCS Content Server 404 that are responsible for signaling and media aspects of data multicast.

In the enhanced BCMCS network architecture is as shown in FIG. 4, the BCMCS content server 404 has the nonstandard ability to originate synchronized unicast sessions and transmit unicast datastreams 422. The role of the SA 424 (in the terms of this invention) is played by a combination of the BCMCS controller and BCMCS content server (that is, the SA has a distributed implementation). The role of the CA 426 is played by a software layer in the mobile terminal.

An example of a BCMCS-based message sequence corresponding to process 300, shown in FIG. 3, is described below. For simplicity, the case of a multicast session with a single media stream S is considered.

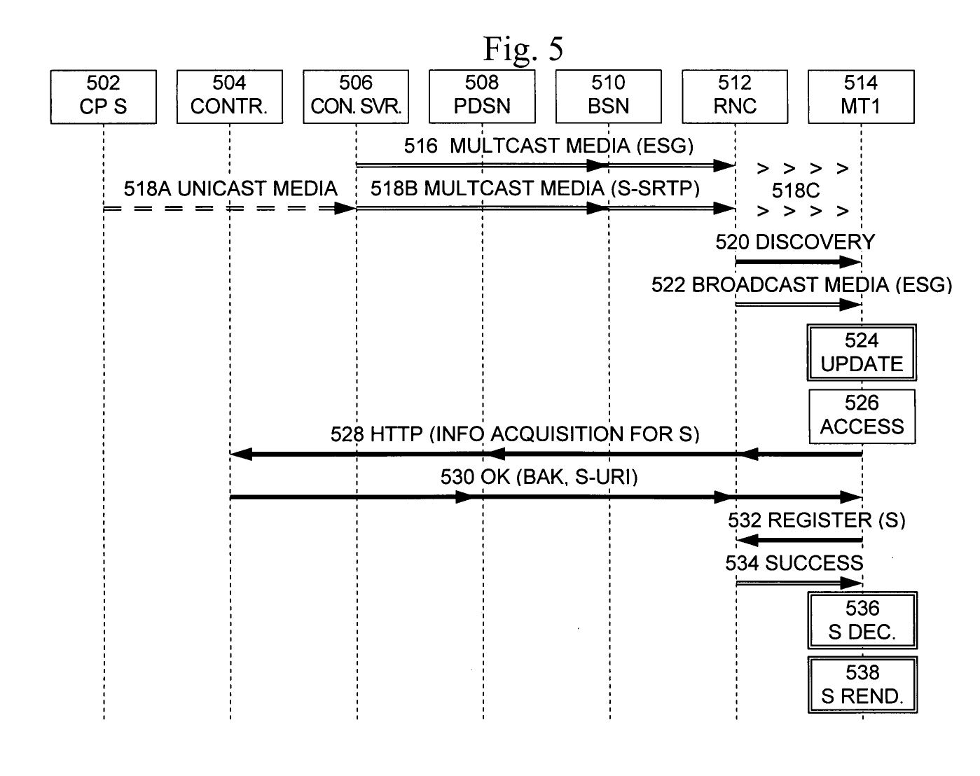

FIG. 5 shows the message flow in a baseline multicast scenario, in which the CA determines that multicast is available. FIG. 5 shows the message flow among various elements of the system, including Content Provider of media stream S (CP S) 502, Controller 504, Content Server (CS) 506, Packet Data Service Node (PDSN) 508, Broadcast Service Node (BSN) 510, Radio Network Controller (RNC) 512, and Mobile Terminal One (MT 1) 514. Also for simplicity, it is assumed that the media session has been set up from the Content Provider (CP S) 502 to the Content Server 506, and that the network is provisioned in such a way that the media is already being multicast within the BCMCS network to all multicast-enabled cell sectors. (BCMCS is capable of dynamic setup of a multicast.) It is to be noted that the present invention is applicable to cell sectors, complete cells, or any portion of a wireless network.

In this case, the Mobile Terminal (MT 1) 514 is assumed to be active in a cell sector in which multicast is enabled. In particular, the Electronic Service Guide 516 is assumed to be available on a multicast channel that is well known or can be discovered by the MT1 514. (Note that this is not yet part of standard BCMCS. An alternative is to discover this information by Information Acquisition queries)

For simplicity, it is assumed that the multicast tree has already been established for the media session of interest, perhaps by static provisioning. That is, a CP 502 is sending a unicast (or multicast) session S 518A that is received by the CS 506, multicast (or multi-unicast) 518B to the network's BSNs, and subsequently tunneled 518C via an appropriate RNC 512 to the base station transmitting in the sector in which Mobile Terminal 1 514 is active. The stream has been encrypted by the Content Server 506.

At the time MT1 514 enters the cell sector, the CA (not shown) or a lower layer of software/firmware discovers 520 via standard overhead messaging the radio parameters needed to access the broadcast/multicast infrastructure. The mobile 514 also now or previously discovers the address of the Controller 504.

The BCMCS infrastructure on MT1 514 acquires the publicly available Electronic Service Guide data 522, including the multicast IP address and port of each stream, and an alternative unicast URL.

The local copy of the ESG data is updated 524.

Some time later (perhaps triggered by a user action), an application on the mobile terminal needs to receive a multicast media or data session and accesses stream S 526. The multicast media or data session is identified by a particular multicast IP address and port (or some other identifier that the CA can use to select the session).

Assuming it has not previously done so, CA sends a BCMCS Information Acquisition HTTP request 528 to the Controller. For simplicity, assume that digest authentication credentials are included and that the nonce is not stale. In this scenario, the request succeeds. The response 530 includes security information.

The CA (assisted by the BCMCS hardware/firmware resident on the mobile terminal) joins the multicast by making a request for registration 532 to the RNC. In this case, it is assumed that the RNC can authorize the request locally, and the request succeeds 534.

The CA may now receive the media session broadcast within the cell sector. The stream is decrypted 536 by the BCMCS platform and/or the CA. The application has access to the packet stream in some appropriate form and may now render the stream 538, as appropriate.

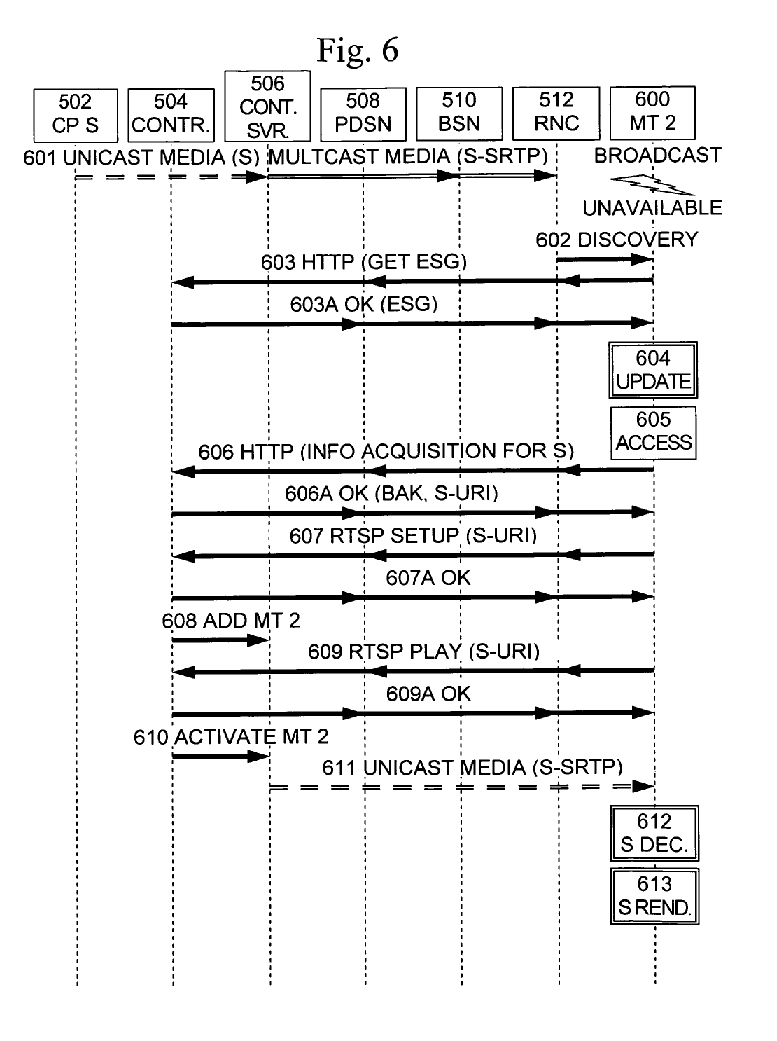

FIG. 6 shows the corresponding multicast/unicast message flow scenario, in which the CA detects that there is no broadcast available in its current location, and sets up a unicast session instead.

As in the previous scenario, the multicast is set up within the network 601, but it is assumed that the particular sector in which the Mobile Terminal (MT 2) 600 finds itself does not have multicast enabled.

MT 2 600 performs discovery 602. In this case it can determine that multicast is not locally available, but it can still discover (via DHCP, for example) the location of the Controller/SA 504. The CA retrieves the ESG by a point-to-point interaction 603, 603A with the Controller. The local copy of the ESG data is updated 604.

Some time later, an application on the mobile terminal needs to receive a multicast media or data session and accesses stream S 605. The multicast media or data session is identified by a particular multicast IP address and port (or some other identifier that the CA can use to select the session).

Assuming it has not previously done so, CA sends a BCMCS Information Acquisition HTTP 606 request to the Controller 504. For simplicity, assume that digest authentication credentials are included and that the nonce is not stale. In this scenario, the request succeeds. The response 606A includes an RTSP URI that can be used for unicast session join, as well as the BAK necessary for decryption via the secure module on the mobile terminal. (Note that this service protection may be necessary even though the connection is secure, since the application may not be trusted.)

The CA now attempts to establish a unicast session using RTSP 607. In particular, the IP address and port on which the CA is listening are provided. (For simplicity in this example, assume that pre-existing digest authentication credentials can be used.) The request succeeds 607A.

Controller 504 instructs the CS 506 to add the unicast destination to the session 608. (Alternatively, the Controller might have redirected the request to the content server.) Once the RTSP session is established, the CA instructs the SA to begin playing the stream 609. The SA responds affirmatively 609A. Controller 504 instructs the CS506 to activate the unicast destination 610. RTP/UDP packets whose payload is a copy of the multicast session being distributed (that is, starting with the packet currently being multicast, not as in a media-on-demand server) are sent to the IP address and port of the CA 611. The session is decrypted by the BCMCS platform and/or the CA 612. The application has access to the packet stream in some appropriate form and may now render the stream 613, as appropriate.

Message flows for session teardown are not shown, but follow the procedure appropriate to the session that was set up (BCMCS de-registration, or RTSP teardown, respectively).

The example previously described, in which there is a single SA and multicast service is either available or not, is merely a simple example. A number of more elaborate examples are described below.

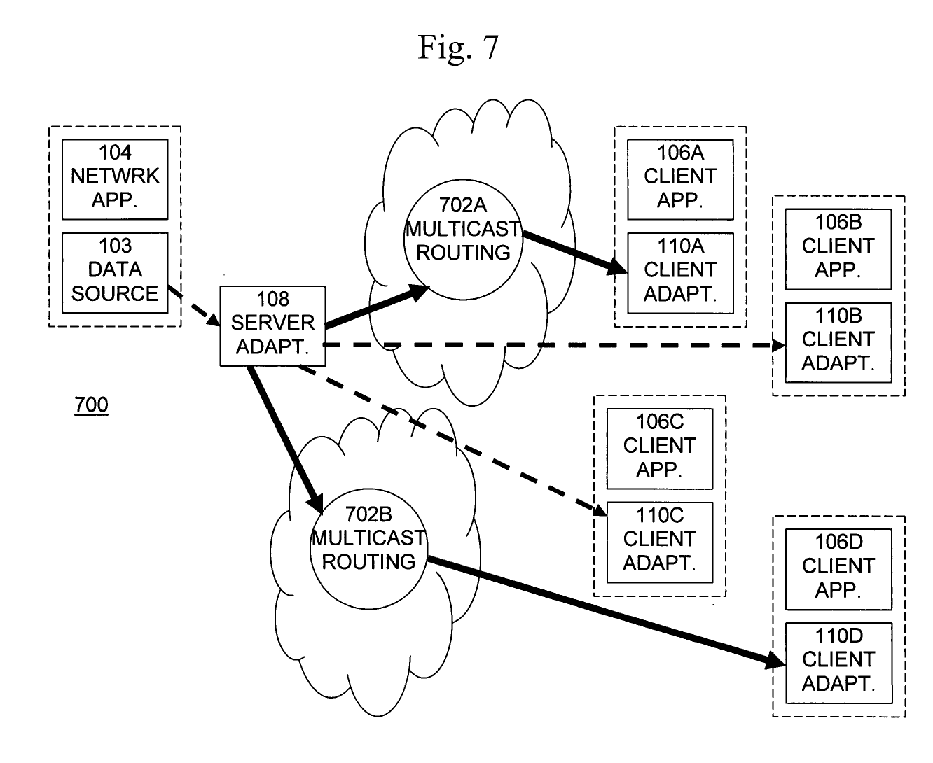

An MC network may be heterogeneous, in that different parts of the network may support different one-to-many mechanisms (including none at all). For example, a network might include cellular data, cable broadband and WiFi subnetworks, each requiring a slightly different MC adaptation. In this case, the SA may not only accept requests for unicast establishment, but may be responsible for distributing the incoming stream to multiple downstream multicast entities, as shown in FIG. 7, which illustrates an example of multi-network adaptation.

In the example shown in FIG. 7, there are a plurality of networks 702A-B having multicast routing capabilities. Also included are Data Source (DS) 103, Network Application (NApp) 104, Client Applications (CApp) 106A-D, Multicast/Unicast (MCUC) Server Adapter (SA) 108, and MCUC Client Adapters (CA) 110A-D. The MCUC SA 108 is responsible for accepting requests from CAs for unicast session attachment, and multi-unicasting to the appropriate addresses using any of the networks 702A-B. It must itself be the recipient of the data session (or a copy of it).

This multi-multicast relationship may be established by configuration or dynamically, but represents an additional function on top of the multicast mechanism within a network of a specific MC type.

It is also possible that the client is capable of receiving MC data from more than one MC network or mechanism. In this case the CA is responsible for discovering and using the most appropriate mechanism. For example, the CA could try to use the highest quality MC mechanism first (to provide the best possible bit rate for the user), a secondary MC mechanism if the best is not available, and so on, falling back to unicast if no MC is available.

One of the benefits of a typical MC network is that it allows massive network scaling, because no single network node (router, for example) sends or receives traffic that scales with the overall number of recipients. Either the physical broadcast mechanism (radio broadcast, for example) is truly insensitive to the number of listeners, or a multicast tree is constructed such that routers need only deal with a small set of local listeners.

When MCUC adaptation is provided, the SA does not have this characteristic. As new unicast listeners are added, not only does the point-to-point data network need to provide resources, the SA must maintain session state and perform the packet duplication necessary to unicast content simultaneously to the set of CAs. While this can be done relatively efficiently compared to the corresponding media-on-demand case, to scale to millions of clients will certainly require the SA to be distributed in some fashion. However, it is important to preserve the characteristic that the NApp send a single data stream to the SA. This requires some form of hierarchy within the SA architecture, such that the data stream is copied to multiple lower level SA entities. Two specific network configurations are distinguished here.

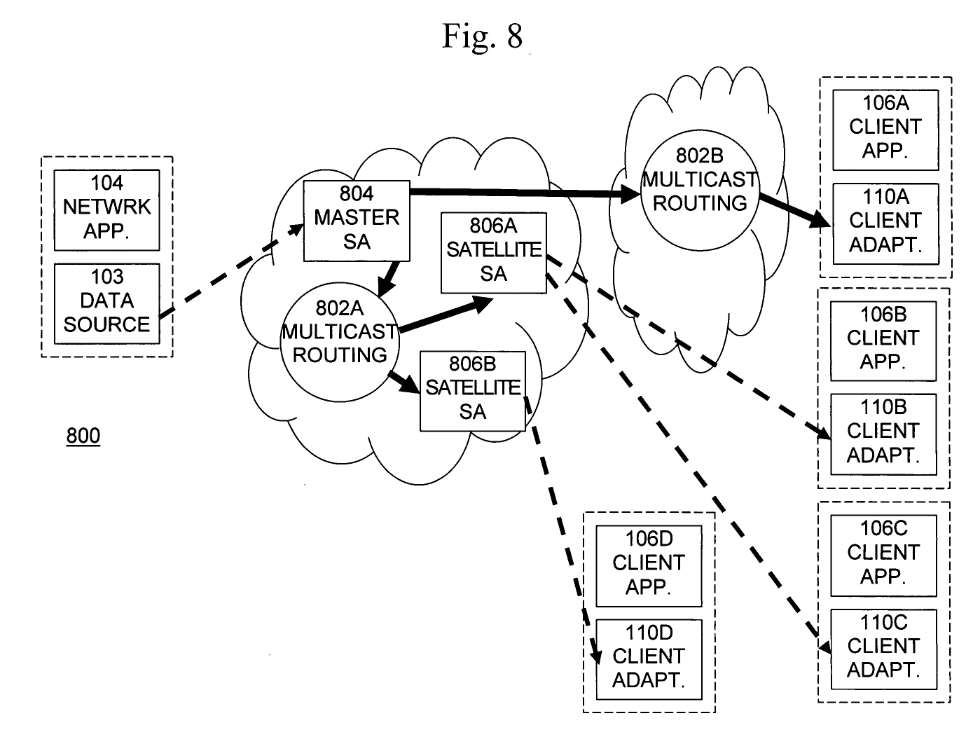

FIG. 8 illustrates an example of a MCUC system 800 having a centralized SA cluster and a plurality of networks 802A-B having multicast routing capability. In a centralized cluster implementation, the hierarchy is local to the SA cluster, which includes a master SA 804 and one or more satellite SAs 806A-B. The DS sends a data stream to a master SA 804, which distributes copies of the stream to the satellite SAs 806A-B. This distribution may use a local communication bus, multicast (the same address as used for MC distribution or a different, local multicast address—the latter is shown in the figure) or multi-unicast. In the latter case there is only a single copy of the stream sent to each satellite SA 806A-B (not one per client). The satellite SAs 806A-B (the leaves of the tree in this hierarchy) are responsible for handling individual client CA unicast sessions.

Load balancing must be provided by a front end that distributes client requests, or by a client-based load balancing mechanism (that is, the client discovers a set of SA addresses and selects one), or by a partitioning mechanism (that is, the client is informed of a specific cluster member based on the client location or identity).

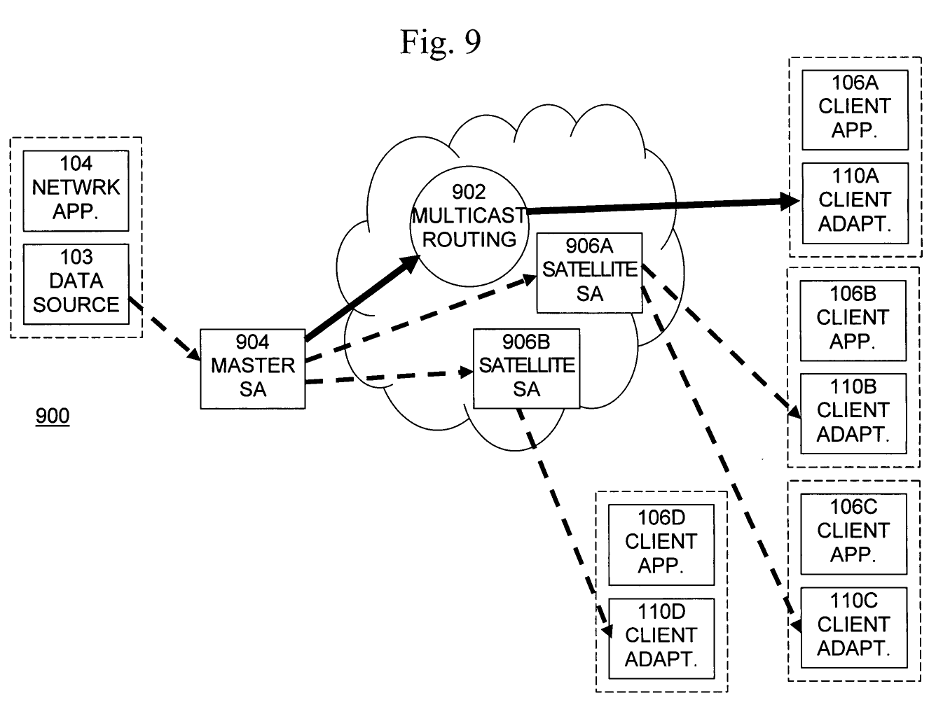

An example of a distributed (hub-and-spoke) implementation of a Multicast-Unicast Server Adapter architecture 900 is shown in FIG. 9. In the example of a hub-and-spoke implementation shown in FIG. 9, the logical relationships are the same, but the satellite SAs 906A-B are distributed throughout the network rather than clustered at a central site. In the example shown in the figure, the client multicast mechanism is not used for media distribution to the satellite SAs 906A-B. This may be necessary because the multicast mechanism used for clients is not suitable for internal network multicast; for example, in the BCMCS case, the multicast mechanism may involve multi-unicast over tunnels to the BSNs in the network.

In this case, the most likely mechanism for association between a client and a satellite SA 906A-B is partitioning based on location: the CA will discover the nearest satellite SA, and will request unicast services from it. In the case that the CA is mobile, an ongoing unicast session may stay attached to the satellite SA 906A-B with which it was established (that is, the existing mobility mechanisms for the underlying data network are relied upon) or may be re-established with a different SA.

The basic procedure shown in FIG. 3, where a CA chooses to use either MC or UC session based on some initial criterion, suffices to provide the simple coverage functionality shown in FIG. 5, and may be sufficient for some versions of the dynamic applications discussed below. However, MC and UC sessions may be advantageously used together rather than as alternatives. With the exception of the mobility scenario in the hub-and-spoke case, the message flows are essentially identical to the basic case.

It is possible for a client to receive data via multiple interfaces and/or network paths. For example, in a cellular data network, a mobile device is typically receiving signals from multiple cell sectors. If the signals are supposed to have the same content, then these signals may be “soft combined” in order to obtain stronger signals. This mitigates packet loss in the case where coverage by any single sector is marginal.

However, there is a multicast/unicast case where a mobile device is primarily in one cell sector and is receiving unicast packets. From time to time, the device may also hear the multicast packets from another adjacent cell sector(s). Alternatively, the CA may be actively listening to both MC and UC in the same sector to mitigate unreliable reception. Traditional techniques for software combine do not work in this scenario since the Radio Networks typically don't understand application/IP level unicast and multicast packets. A similar situation arises when there are multiple MC mechanisms available, even where the individual MC technologies provide software combine.

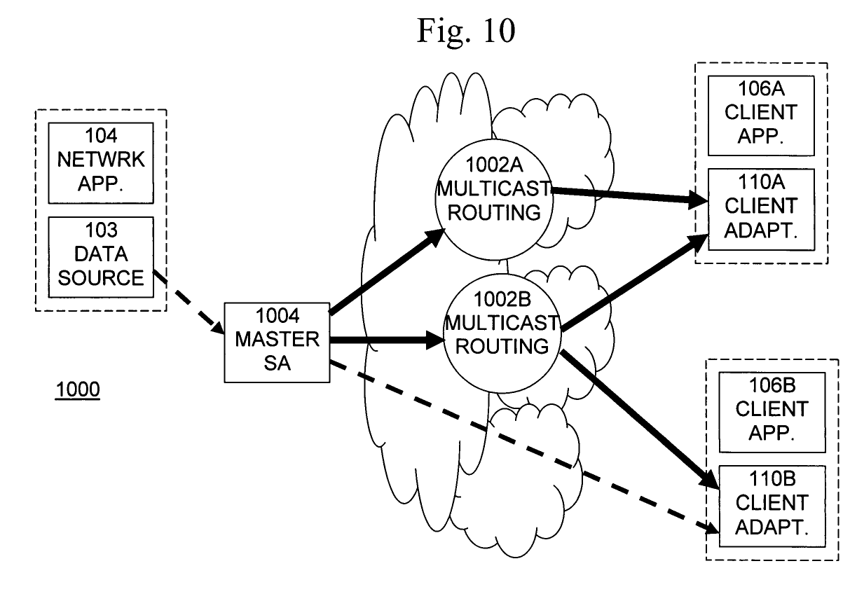

An enhancement to the CA adds functionality to take advantage of multiple copies, for this and any similar case in which multiple copies of lossy data sessions can be received by the client, and advantageously merged. The SA and CA ensure that the data session includes sufficient synchronization markers, consistent timestamping, or additional synchronization information so that multiple sessions may be merged An example a system 1000 including this application level soft combine is shown in FIG. 10. The figure illustrates two cases: the most typical case, where a single multicast and a unicast are merged (in CA 110B); and a case in which two multicast sessions using different distribution mechanisms are merged (in CA 110A).

The resulting data stream, in whatever form it is presented (internal memory buffer, for example), appears as a single stream to the higher-level software, which remains unaware of the multicast/unicast implementation. Depending on the requirements of the higher layer, the CA may provide duplicate packet removal and/or packet reordering as part of the merge.

When a CA needs to switch from MC to UC dynamically (or vice versa), it may be important to avoid packet loss during the transition, thus providing seamless switching. The soft combine of the previous section may be advantageously used temporarily during a switch, ensuring enough overlap that packets are not lost. That is, the CA initiates the UC session, but does not terminate the MC session until the UC session is established. The same synchronization and duplicate removal functions as above ensure a smooth transition.

A further enhancement to any MCUC switching or overlay procedure can be provided by allowing finer-grained control of the media flow within the UC session. Specifically, it may be possible for the CA to establish the session with the SA, but control whether or not the data stream is actually sent. In many types of underlying point-to-point data networks, this provides improved latency in MCUC switching without using critical bandwidth resources.

Many of the candidate protocols for setup of the UC sessions between CA and SA provide a way for the client to have this kind of control. For example, an RTSP client may set up the session, but use PAUSE and PLAY messages to stop and start the flow of media packets.

If the resource tradeoffs are favorable (including the load on the SA), the CA can establish a UC session and maintain it throughout the course of an MC session, avoiding the latency (and overhead) of tearing down and re-establishing the session when it is required. Alternatively, the UC session could be created in a lazy fashion, such that the CA creates a UC session when first required, and maintains it from then through the termination of the overall session.

The procedures described above may be advantageously used under circumstances where the client experiences unreliable multicast service. Specifically, when multicast reception is becomes unsatisfactory, based on its measurement of multicast quality of service (QoS), the CA switches from MC to UC. When the multicast quality improves, the CA switches back. The client application is unaware of the switch, except that some packets may be lost during these transitions.

The multicast reception quality may vary during a session for a number of reasons, including mobility within a cell in the mobile client case. The case where mobility causes handoff between cells is described as a separate application below. The case where multicast availability changes as a result of a network resource decision triggered by the activity of other users is described as a separate application below.

The decision to switch from MC to UC (or to initiate UC media as an overlay) can be based on a variety of information available to the CA. This includes but is not limited to

Packet drop and error rate

Radio signal level and signal-to-noise ratio

It may be important to apply appropriate hysteresis control to avoid unnecessary thrashing between modes. The thresholds for switching must be chosen in such a way as to avoid repeated mode switching under marginal connectivity conditions.

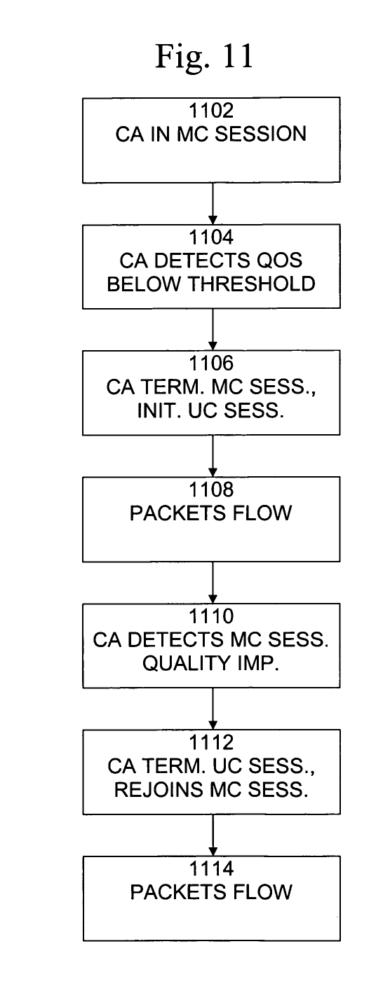

A basic switching scenario is shown in FIG. 11. The scenario begins with step 1102, in which the CA is involved in an MC session. In step 1104, the CA detects that the MC session QoS has dropped below a critical threshold. In step 1106, the CA terminates the MC session and initiates a UC session. In step 1108, packets continue to flow to the application using the UC session.

At some time later, MC session quality improves. In step 1110, the CA detects the improvement in the MC session quality of service. The CA may, for example, detect this improvement by continuing to participate in the MC session, or by periodically attempting to rejoin the session. In step 1112, the CA terminates the UC session and rejoins the MC session. In step 1114, packets continue to flow to the application using the MC session.

In this case, the CA may perform some cleanup of the data stream (eliminating duplicate packets, for example) but does not attempt to otherwise merge the streams. This means that packets can be lost at more than the usual rate from the MC session at points just before a switch from MC to UC, or just after a switch from UC to MC. This may or may not be an issue, depending on the application.

The scenario of FIG. 11 may be improved by employing the seamless switching technique. In this case, the switched-from session is not dropped (or ignored) until the switched-to session is fully established, and the overlapping sessions are combined to reduce packet loss during the transition.

In cases where MC reliability is marginal, it may be advantageous to employ the soft combine technique. In particular, it may be useful to employ a two-stage transition such that the CA adapts from MC to combined MC/UC to UC only, and vice versa as MC QoS improves. This has the advantage of providing some hysteresis automatically, as well as dealing with the cases where both UC and MC reception is marginal and soft combine provides a significant improvement in application-level QoS.

The UC session control enhancement described below may be advantageously used in this scenario as well. In order to avoid packet loss as the MC session QoS degrades, it may be important to initiate the UC session as rapidly as possible. It will typically be much quicker to start media flow on an existing UC session than to establish a new session when required.

MCUC adaptation may have some special benefits in the case of a mobile client (that is, the environment of the CA is changing over time, even during the course of a multicast session, because the client moves from one part of the network to another). The procedures are similar to the reliability scenarios described in the previous sections, but there are some differences in the details.

The main scenarios of interest occur when a client moves from one area of the network to another during a session, and there is a difference in the availability of MC between the two areas. It is assumed that the point-to-point data network is always available, and that the network provides mobility for unicast traffic in a way that is transparent to the CA and SA (via Mobile IP, for example, as in the case of CDMA2000 data networks).

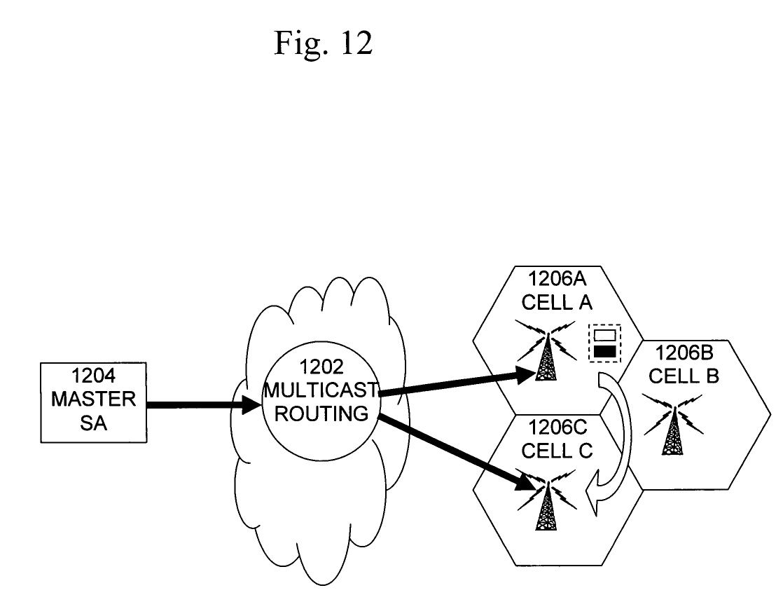

The important topology is then the cell structure of the MC network, as shown in FIG. 12. In this example, an SA, such as master SA 1204, communicates via network 1202, with multicast routing capability, to wireless cells 1206A-C. The term “cell” in this case is generically used to refer to the extent of propagation of the signal from a specific MC packet routing source in the network. This may correspond to

A cell sector or cluster of cell sectors in a cellular data network

The area within the radius of a radio broadcast tower

The coverage area of a satellite

When the MC technology supports seamless handoff itself, it may be reasonable to think of the “cell” as the aggregate of all adjoining regions with the same MC availability.

Cells may overlap as well, though this is important in the current context primarily when there multiple MC mechanisms available.

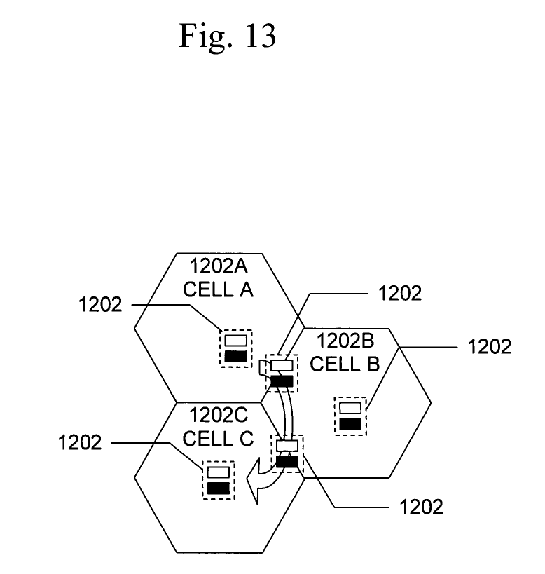

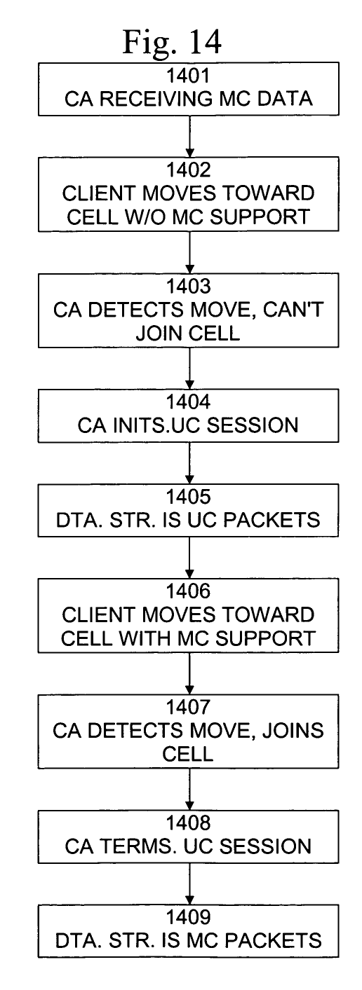

A example of a simple handoff scenario is shown in FIG. 13. In this example, the CA switches from one mechanism to another as the client moves from one cell to another, such as cell 1202A to cell 1202B to cell 1202C. A process 1400 for performing the handoff is shown in FIG. 14, which is best viewed in conjunction with FIG. 13. Process 1400 begins with step 1401, in which the CA is receiving MC data from the source in cell A 1202A. The packet stream is being processed by the application. In step 1402, the client moves from cell A 1202A towards cell B1202B, which does not support MC. In step 1403, the CA (or some lower layer) detects the move and attempts to join the MC in cell B. Depending on the details of the MC handoff technology, this attempt may happen before or after MC delivery from the cell A 1202A source becomes disrupted. The attempt fails. In step 1404, the CA initiates a UC session with the appropriate SA (previously discovered or discovered dynamically). In step 1405, the data stream provided for the CApp is now based on packets from the UC session.

In step 1406, the client moves from cell B 1202B towards cell C 1202C, which does support MC. In step 1407, the CA (or some lower layer) detects the move and attempts to join the MC in cell C 1202C. The attempt succeeds. In step 1408, the CA terminates the UC session with the SA. In step 1409, the data stream provided for the CApp is now based on packets from the MC source in cell C 1202C.

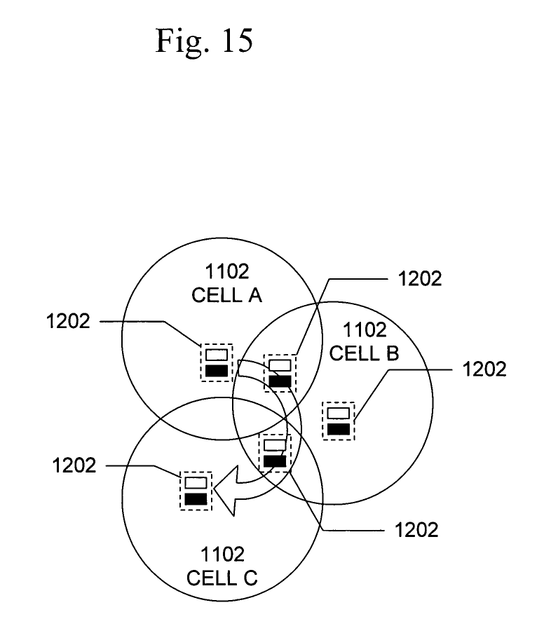

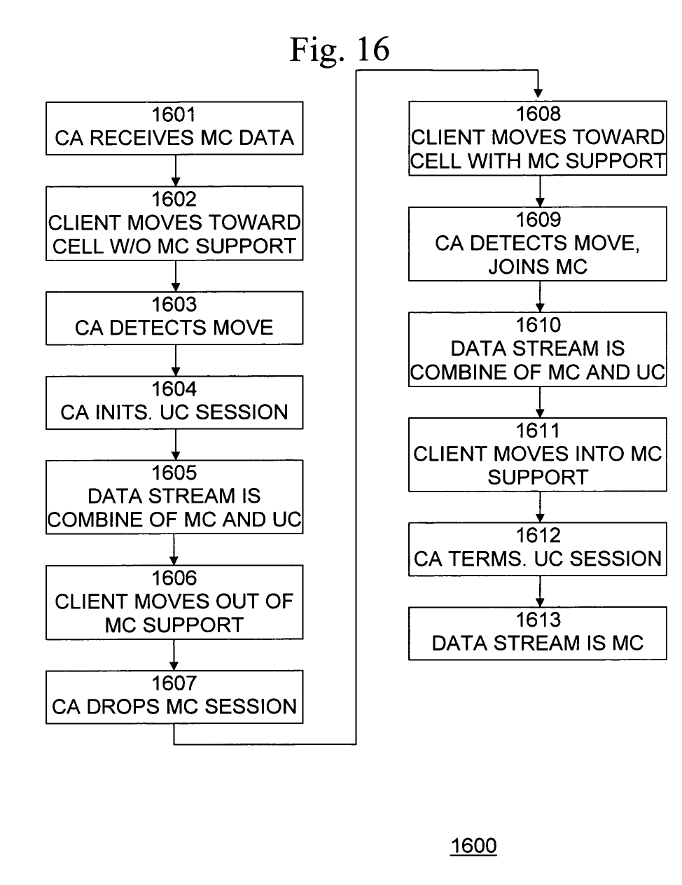

If packet loss during handoff is unacceptable, the CA can provide enhanced functionality by making use of the software combine mechanism described above. This requires the CA to preemptively establish and/or continue to maintain a UC session even when MC reception is adequate, and involves finer-grained mobility awareness than the previous case. An example of such a soft handoff is shown in FIG. 15. A process 1600 for performing the handoff is shown in FIG. 16, which is best viewed in conjunction with FIG. 15. Process 1600 begins with step 1601, in which the CA is receiving MC data from the source in cell A. The packet stream is being processed by the application. In step 1602, the client moves from cell A towards cell B, which does not support MC. In step 1603, the CA (or some lower layer) detects that the imminent move into cell B will result in the loss of MC data, although MC is still being successfully received. This detection might happen as a result of the underlying MC handoff mechanism (especially if low-level combine is being used as part of that technology), or as the result of QoS monitoring and discovery by the CA. In step 1604, the CA initiates a UC session with the appropriate SA (previously discovered or discovered dynamically). In step 1605, the data stream provided for the CApp is now based on app-level soft combine of packets from the cell A MC source, any other low-level or soft combined MC sources, and the UC session. This continues as long as the client is in region A+B.

In step 1606, the client moves toward cell B and out of cell A completely. MC is no longer available at any QoS level. In step 1607, the CA drops the MC session. The data stream is now completely provided by the UC session. In step 1608, the client moves from cell B towards cell C, which does support MC. In step 1609, the CA (or some lower layer) detects the move and attempts to join the MC in cell C. The attempt succeeds. In step 1610, the data stream provided for the CApp is now based on app-level soft combine of packets from the cell C MC source, any other low-level or soft combined MC sources, and the UC session. This continues as long as the client is in region B+C.

In step 1611, the client moves further into cell C. Based on QoS (power level, packet loss, availability of MC soft combine . . . ) criteria, the CA decides that UC adaptation is wasteful and that the MC stream from the cell C source is adequate. In step 1612, the CA terminates the UC session with the SA. In step 1613, the data stream provided for the CApp is now based on packets from the MC source in cell C.

Some refinements of the above procedure may be necessary if the MC is re-established in such a way as to be incompatible with the UC connection. For example, the MC for the particular session of interest may be available in cell C on a different frequency than in cell A, and it may not be possible for the mobile device to simultaneously listen to the already established UC session (if this transition is not handled transparently by the underlying wireless data infrastructure). In this case, the CA may need to explicitly terminate the UC session and re-establish it afresh.

As in the reliability/QoS application shown in FIG. 11, the latent UC session capability may be used to improve the switching speed and hence packet loss in the mobility scenarios above. This relies on the underlying mobile data network maintaining the session as the client moves through the network; if this is not the case, the CA may need to re-establish the latent UC session periodically.

The CA and SA may additionally provide functionality to allow the choice of multicast versus unicast to be based on dynamic network decisions. That is, both multicast and unicast data sessions may be feasible for a particular client, but the decision as to which to use depends on factors that the client cannot evaluate. Moreover, this decision may change with time, even after the initial involvement of the client in the session. To support these capabilities, the SA not only contributes to the initial decision, but also may subsequently notify CAs that a switch from unicast to multicast, or vice versa, is required.

The decision to switch from MC to UC or vice-versa may depend on a number of factors, but the scenario of primary interest is triggered in the mobile case by a change in the number of multicast clients within a particular cell sector. In this case, the SA must decide whether the bandwidth and processing resources of the radio infrastructure are best allocated to a multicast or to multiple unicast sessions.

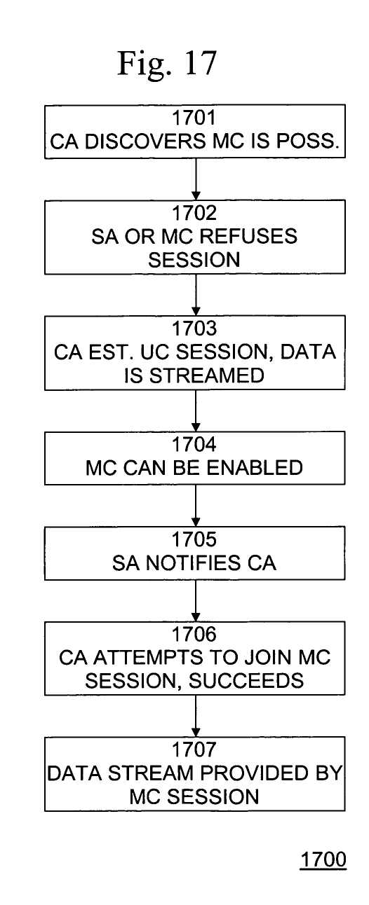

An example of a process 1700 of unicast to multicast switching based on dynamic resource optimization is shown in FIG. 17. In this case, the client initially establishes a UC session, but must change to multicast. The process begins with step 1700, in which the CApp needs to join an MC session. The CA knows (or discovers) that MC is possible in the current location, and attempts to join an MC session. In step 1702, the SA (or the local MC infrastructure) refuses to authorize the MC session. (For example, because not enough clients within the cell sector require MC for that particular session.) In step 1703, the CA establishes a UC session, and data is streamed to the application.

At some later time, in step 1704, conditions become favorable for enabling MC for the session. (For example, because enough other clients have requested the same session within the same sector.) In step 1705, the SA notifies the CA that MC is now enabled. Typically this will be done using a message within the UC session, but other mechanisms are possible. In step 1706, the CA attempts to join the MC session, and this time succeeds. The UC data session is no longer required. Optionally, a soft handoff enhancement to this procedure may be performed, as described below. In step 1707, the application data stream is now provided by the MC.

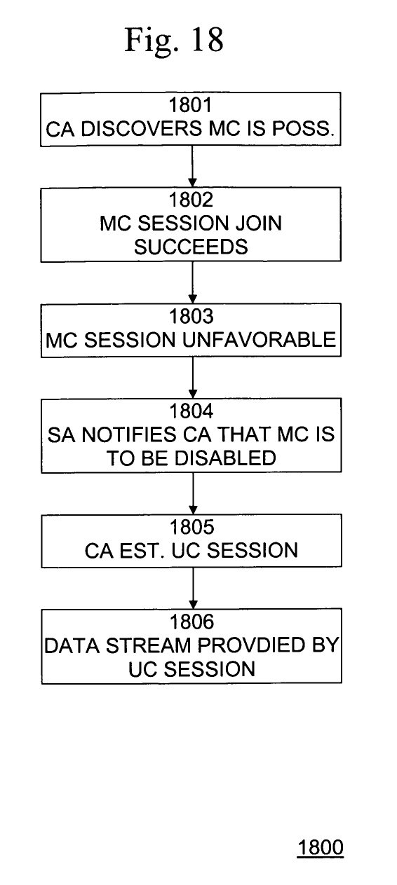

An example of a process 1800 of multicast to unicast switching based on dynamic resource optimization is shown in FIG. 18. In this case, the client initially establishes a UC session, but must change to multicast. The process begins with step 1801, in which the CApp needs to join a session. The CA knows (or discovers) that MC is possible in the current location, and attempts to join an MC session. In step 1802, the MC session join succeeds, and data is streamed to the application.

At some later time, in step 1803, conditions become unfavorable for a local MC for the session. (For example, because other clients that requested the same session within the same sector have stopped listening or have left the sector.) In step 1804, the SA notifies the CA that MC is about to be disabled. This may be achieved by embedded broadcast messaging, a separate unicast control message (see below for a specific example), or in the worst case simply by terminating the multicast. In step 1805, the CA establishes a UC session. The MC data stream is no longer required, even if temporarily available. Optionally, a soft handoff enhancement to this procedure may be performed, as described below. In step 1806, the application data stream is now provided by the UC session.

The enhancements described for the reliability scenarios in section 2.6 can be applied to network-initiated switching, with appropriate integration with the SA. Unlike the handoff and reliability usages, it is assumed that either UC or MC session QoS would be adequate, if available; the trigger for switching in this case is the notification from the SA that a multicast session is about to become fully unavailable or fully available. Because this notification may precede the change by some short time, it is still possible to apply some of the enhancements described earlier.

If the notification infrastructure allows sufficient warning, the CA may establish a UC session in advance of the termination of the MC session, performing seamless switching or soft combine until the MC is no longer available. This prevents packet loss during the switch.

When notified that MC is available for a session that is currently being received using UC, the CA may be capable of retaining the UC session after initiation of the MC session, performing application level soft combine until the MC is fully established. This prevents packet loss during the switch. (As usual, this is dependent on the ability of the client platform to listen to both sessions simultaneously.)

The UC session control enhancement described above can be applied to the switching scenarios as well. In this case the CA will be aware that it is in an environment in which MC-UC switching is required, and will preemptively establish a UC session even if MC is currently available. This allows the media flow for the UC session to be started and stopped by the CA as required by the switching indications from the SA (or as otherwise detected by the CA), just as in the similar cases above.

However, there is an additional possibility in this case if the SA controls the switching: the SA may stop and start the UC session in a coordinated way with the MC availability. In fact, the UC session may be used as the mechanism for the SA to indicate the changes to the MC status (for example, using an RTSP ANNOUNCE message).

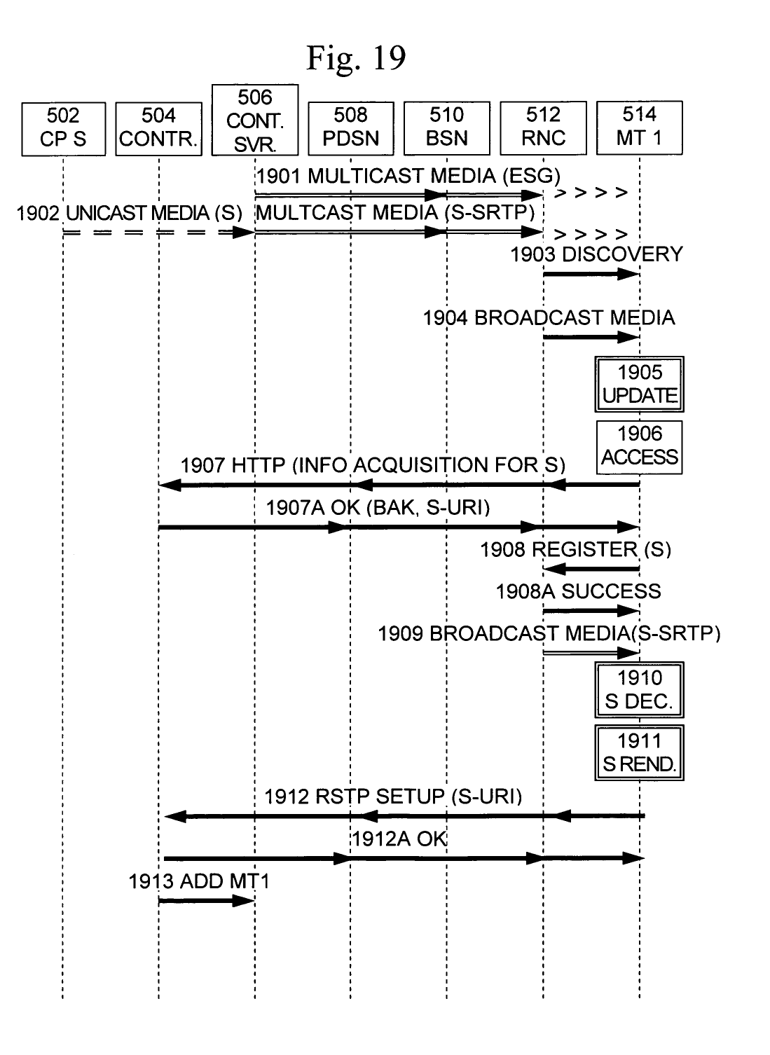

The exemplary message flow shown in FIG. 19 illustrates the procedures described above. In the example of FIG. 19, a multicast session is initiated as previously, but a latent UC session established. Steps 1901-1911, shown in FIG. 19, are similar to steps 516-538, shown in FIG. 5, and described above. Then, after establishing a multicast stream, the CA in MT 1 514 additionally initiates a unicast session by sending an RTSP request 1912 to the Controller/SA, which is accepted 1912A. However, the CA does not yet initiate media packet sending. The Controller 504 allocates resources by adding 1913 MT 1 514 on the Content Server 506, but does not yet activate the UC media stream.

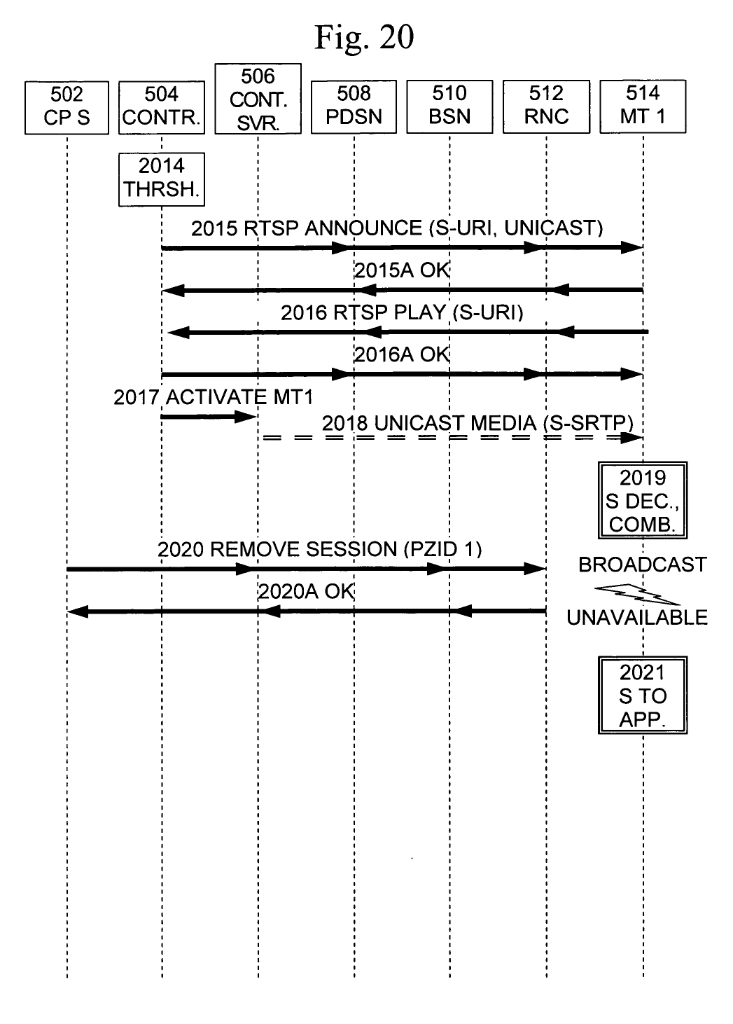

Turning now to FIG. 20, at some later time, as shown in FIG. 20, the SA decides to de-authorize multicast in the packet zone of MT 1, perhaps because there are no longer enough multicast listeners. The CA is informed, and switches to unicast. In particular, controller 504 decides multicast is not optimal in MT 1's zone (PZID 1) 2014, such as when a low threshold for MC service is reached. Controller 504 uses latent UC session to notify MT 1 that the session is going to be unicast only, by using an RTSP ANNOUNCE message that updates the session parameters 2015. The CA in MT1 514 initiates the streaming of media with an RTSP PLAY request 2016. The Controller/SA 504 activates 2017 the streaming of media packets at the Content Server 506. Media packets begin to flow 2018 on the unicast stream. The CA is temporarily able to soft combine the UC and MC streams 2019. The Controller/SA 504 communicates with the BSN to deactivate the session 2020 from multicast in PZID 1, and is successful 2020A. Stream S is no longer broadcast in those sectors. The CA now uses only the unicast stream to supply the media packets to the CApp 2021.

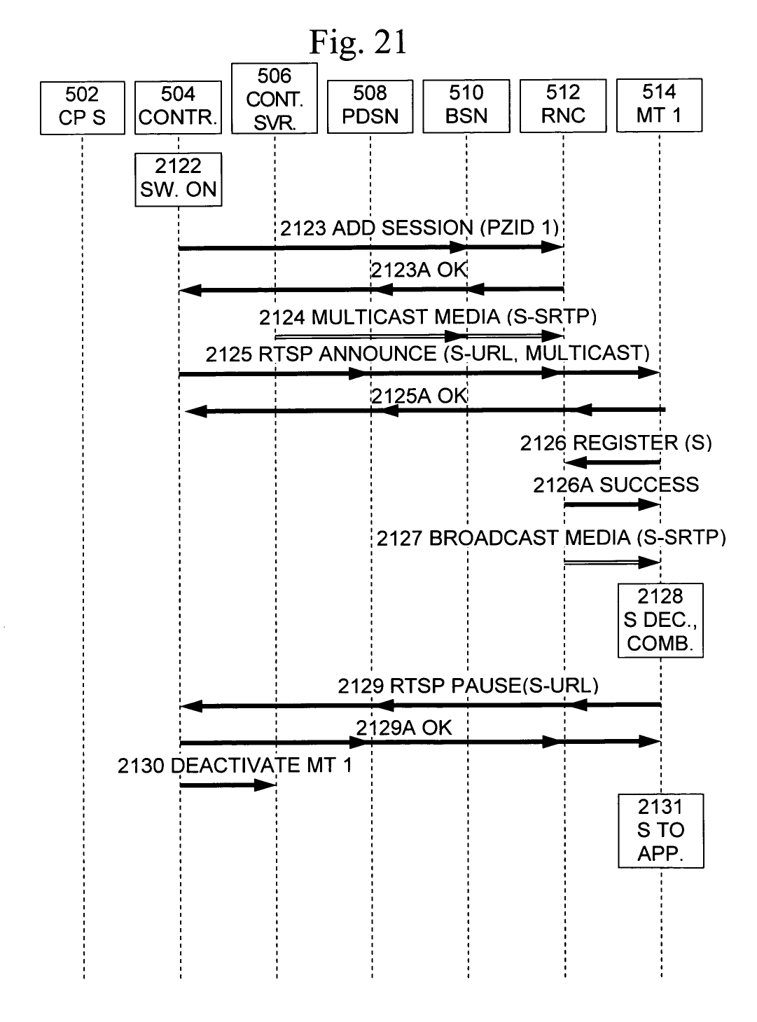

At some even later time, as shown in the example of FIG. 21, the SA decides to re-authorize multicast in the packet zone of MT 1, perhaps because there are now enough potential multicast listeners to make multicast optimal. The CA is informed, and switches back to the multicast. The Controller/SA 504 determines that multicast is currently available, such as when MC is switched on in the sector 2122. The Controller/SA 504 communicates 2123 with the BSN 510 to reactivate the multicast session in PZID 1, and succeeds 2123A. Stream S is now broadcast in those sectors 2124. Controller 504 uses latent a UC session to notify MT 1 514 that the session is going to be available as multicast, by using an RTSP ANNOUNCE message 2125 that updates the session parameters. This succeeds 2125A. The CA (assisted by the BCMCS hardware/firmware resident on the mobile terminal 514) joins the multicast by making a request for registration 2126 to the RNC 512. The CA may now receive the media session broadcast 2127 within the cell sector. The multicast stream is decrypted by the BCMCS platform and/or the CA, and may temporarily be soft combined 2128. The CA determines that soft combine is unnecessary, and sends an RTSP PAUSE request 2129 to turn media packet streaming off in the UC session. This succeeds 2129A. The Controller/SA 504 deactivates 2130 the streaming of media packets at the Content Server 506. The CA continues to use the MC session 2131.

The discussion above does not, however, address the question of when the switching should take place. In general, the network resources needed to deliver a unicast session to a single user are less than the resources it takes for a broadcast session. For instance in a CDMA system, a unicast session has precise power control thus it is highly efficient. A broadcast session typically has no or little power control thus it requires more network resources. However, when the number of unicast sessions reaches a certain point, it is more efficient to use multicast instead since multicast only sends out one stream to multiple users while unicast sends multiple streams to multiple users. The exact threshold depends on many factors: air interface technology, user density, network/operator policies, etc.

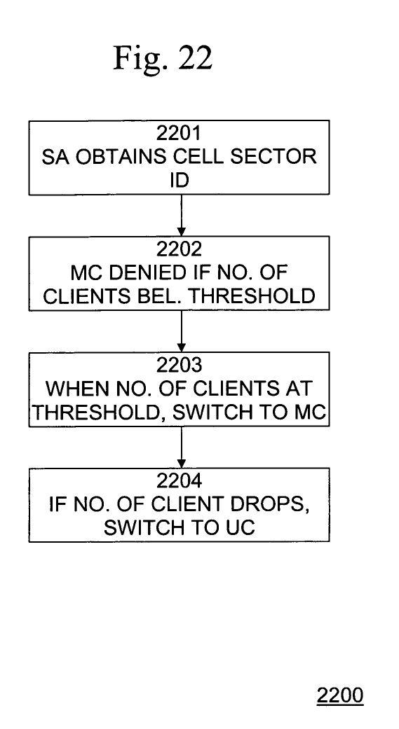

A simple example of a threshold-based policy 2200 for the 3G Wireless domain is shown in FIG. 22. In step 2201, the SA obtains the Cell Sector ID from any mobile client that joins a multicast or a multi-unicast session. In this scenario, the SA is also the multicast/broadcast controller. The SA keeps track of the number of clients active for a session, and whether multicast or unicast, in each sector. (Note that a device may connect to more than one cell sector; the SA keeps track of it.) In step 2202, a request for multicast participation is denied in favor of unicast if the number of clients in a sector active for that session is currently below a threshold Tₒₙ.

In step 2203, when the number of clients active for a session in a sector reaches Tₒₙ, the sector is switched to multicast, the multicast request is allowed and the unicast clients' CAs are notified of the switch. The CApp on each is unaware of the change. In step 2204, when multicast is in use for a session in a sector, and the number of clients active for that session in that sector drops below a different threshold T_{off} (less than or equal to Tₒₙ), the sector is switched to unicast, and the multicast clients' CAs are notified of the switch.

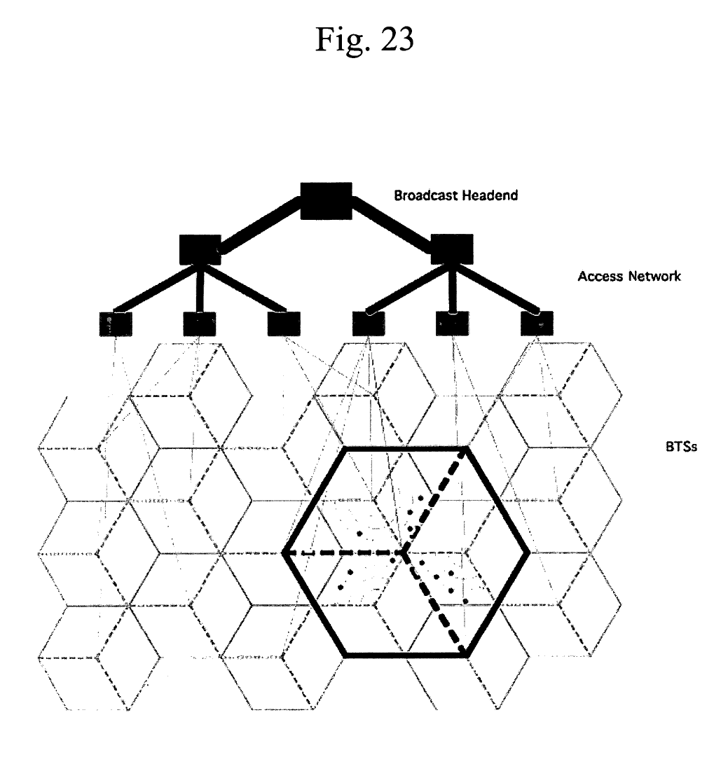

A more optimal policy of threshold-based multicast and multi-unicast switching could be based on measurements of a cluster of adjacent cells so that the switching decision is based on what is optimal within a cluster of cells rather than in a single cell. The reason for better performance is that multicasting in one cell sector can have a positive effect on the mobiles in the adjacent cell sectors. Often times a mobile can simultaneously connect with the multicast sessions in adjacent cells and perform soft combine at the physical layer or at the application layer to achieve better reception. However multi-unicasting does not enhance the reception of other mobiles in the adjacent cells. Some networks have overlay of macro- and micro cell sectors. Macro cells are bigger and are usually overlaid over multiple micro-cell sectors. Multicasting in a macro cell certain benefits all the micro cells that are overlaid. An example of this network cell topology is shown in FIG. 23. It is highly likely that multicast from the macro cell sectors is more efficient than multicast or multi-unicast from the micro cells. So the decision to switch should consider the enhancement that multicast has on adjacent cells or the overlaid cells. For convenience, we refer adjacent and overlaid cells both as adjacent cells below.

In a large geographic area with many cell sectors, assume at the beginning no users are on, and one by one mobiles start listening to the same session, which cell sectors should turn on multicast and which should use unicast? As time goes on, more mobiles join, some mobiles will quit the session, and some will move to other cell sectors, how is the multicast and multi-unicast decision made dynamically?

There may be constraints placed by the network and the operator that need to be taken into consideration. One constraint might be some cell sectors cannot provide the multicast capability. In this case, turning on multicast in a cell sector cannot benefit the subscribers in the adjacent unicast only cell sectors. Another constraint might be an operator has a pre-defined content distribution territory for business reasons. For example, a live major league baseball game can only be distributed in Boston. So only users who are located in Boston can watch the game. If a user moves out of Boston during the game, that user will lose the connection. It is also possible that the availability of a particular program can be based on the level of subscription of a user. For instance a platinum user who pays more for the content can get the game regardless of location, but gold and silver users can only get the game in the predefined area. The impact on optimization is that: when the user moves out of the predefined territory, the user may or may not be allowed to handoff.

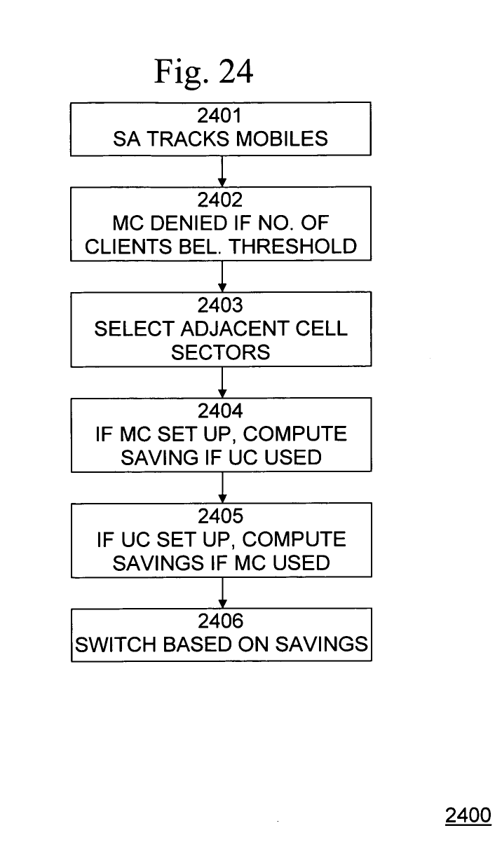

The optimization goals should be to reduce network resources consumed while keeping the overhead of switching small (e.g., by using messages that manage the switching). An example of such an optimization process 2400 is shown in FIG. 24. The process begins with step 2401, in which the SA keeps track of number of mobiles in every cell sector that are listening to the session. This can be done through correlating the mobile with its current cell ID(s). Each cell ID identifies the cell sector the mobile is connected to. There could be multiple cell IDs at a time. If a mobile moves, through handoff messages, SA can detect the change in cell IDs. However, if a mobile turns off his phone without deregistering, then the SA would not know. A light-weight heartbeat can be passed between the SA and the CA in order to keep the accurate count of the number of mobiles in A.

In step 2402, a cell sector (A) in which the multicast/multi-unicast decision needs to be made is selected. In step 2403, a cluster of cell sectors adjacent to cell sector A is selected. The cluster typically includes the 3-7 cell sectors surrounding A and it can also include a macro cell overlaying A. The basic idea is that the signals from cell sector A should be heard by mobiles in the adjacent cells.

In step 2404, if a multicast session is already set up in A, compute the net network resource savings if unicast were to be turned on. The net network resources savings come from two part: 1) the resource savings in cell sector A. 2) the resource savings lost in adjacent cells due to the loss of soft combine in adjacent cells. Such computation typically requires setting up the mathematical models or using simulation models of the air interfaces of the cluster of cells. We will not include how the model is set up in this patent. Through modeling, the net effect of network resource savings can be computed at the same time due to switching.

In step 2405, if a unicast session is already set up in A, then compute the net resource savings in A if multicast were to be turned on. The net resource savings come from two part: 1) resource savings in cell sector A. 2) the resource savings in the adjacent cells due to soft combine. In this step, the constraints placed by the network or the operator should be taken into consideration as well. For instance, if cell sector A does not support multicast, then the decision is simple: no multicast. A scenario could be: some of the adjacent cells do not support multicast or are not allowed to provide multicast. This could happen if the broadcast territory boundary happens to fall between cell sector A and an adjacent cell, multicast/unicasting in the adjacent cell is not allowed according to the policy. The net effect of the adjacent cell's inability to provide multicast is that it reduces the positive effect of soft combine.

In step 2406, if the net network resource savings from step 2405 or 2406 is negative, then multicast-unicast switching is not performed. If the net network resource savings from step 2405 or 2406 is positive, and it exceeds a threshold, then the multicast-unicast switching is performed.

The threshold can be computed/pre-defined by taking into consideration of the overhead of switching. It can also take into consideration the predictive behavior of mobile users. For instance, the threshold can be a function of the predictive number of mobile users in cell sector A a certain number of minutes from now. Is the number of mobile users in cell sector A decreasing or increasing? If it is decreasing, the threshold can be higher for unicast to multicast switching. If it is increasing, the threshold can be lower for unicast to multicast switching.

Once the decision of to switch is made, then the procedures for executing the switching will be implemented as described above. Another consideration is the frequency of this computation and switching. This decision needs to be weighed against the overhead of switching also.

An issue for many multicast/broadcast mechanisms, such as DVB-H is the latency in tuning to a particular “channel” (i.e., session in the terminology of this document). It may be the case that point-to-point interactions are significantly faster than the tuning operation of the multicast receiver.

In this case, MCUCA and the latent UC session capability can be advantageously employed to shorten the delay the application (and hence user) see in receiving the first packets within the new session. This is particularly important in an application such as mobile television where the user would like to “surf” the channels.

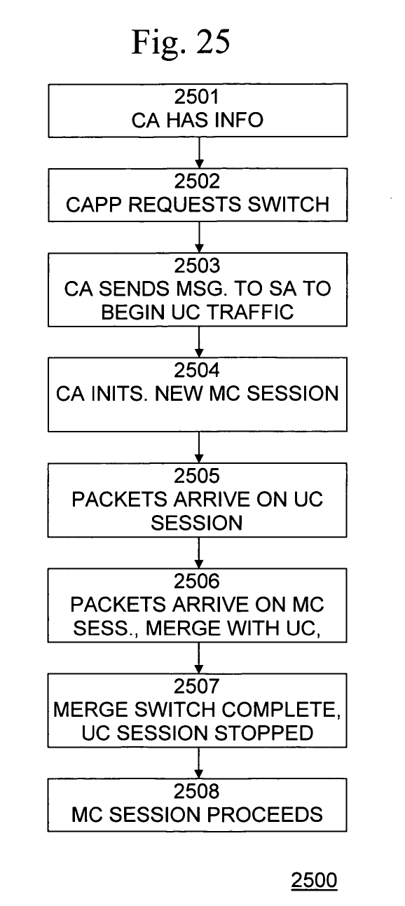

An example of a process 2500 of switching between channels is shown in FIG. 25. A similar process may be used for initiation optimization as well. Process 2500 begins with step 2501, which may be considered to be a precondition for the process. Assume for simplicity that the CA has obtained all necessary multicast addressing and security information for the switched-to session as well as the current session. Also assume that a UC session was established to the SA when the current session was initiated, or when the application was started. In step 2502, the CApp (prompted by a user action) requests a switch to a new session. In step 2503, the CA sends a message to the SA to begin sending UC traffic for the new session. Ideally, this reuses, for latency reasons, the control connection already established to the SA, though this may depend on the protocol used for that control. In step 2504, in parallel with step 2503, the CA initiates the network or local platform interaction necessary to begin receiving traffic on the new MC session. This join operation is assumed to take some time (that is, there is a delay until the first packet within that MC session is received by the CA). In step 2505, packets begin to arrive on the UC session and are forwarded to the CApp. The application session (e.g., video display) begins.

In step 2506, some time later, packets begin to arrive on the MC session. The seamless switching capability described above is used to merge the UC and MC session packets. In step 2507, once the merge/switch is complete, the CA sends a message to the SA to stop packet flow on the UC session. In step 2508, the MC session proceeds.

Although specific embodiments of the present technology have been described, it will be understood by those of skill in the art that there are other embodiments that are equivalent to the described embodiments. Accordingly, it is to be understood that the technology is not to be limited by the specific illustrated embodiments, but only by the scope of the appended claims.

1. A method of transmitting data traffic comprising:
transmitting data using a multicast session to a plurality of destinations;
determining that the multicast session to at least one of the destinations of the plurality of destinations should be switched to a unicast session to the at least one destination; and
switching the multicast session to the at least one destination to a unicast session to the at least one destination.

2. The method of claim 1, wherein the determination that the multicast session to the at least one destination should be switched to a unicast session to the at least one destination is based on a quality of service of the multicast session.

3. The method of claim 2, wherein the determination that the multicast session to the at least one destination should be switched to a unicast session to the at least one destination comprises:
determining that the quality of service of the multicast session to the at least one destination has fallen below a threshold.

4. The method of claim 1, wherein the determination that the multicast session to the at least one destination should be switched to a unicast session to the at least one destination is based on an availability of the multicast session.

5. The method of claim 4, wherein the at least one destination is a mobile client, the data is transmitted to the mobile client using a mobile network, and the availability of the multicast session is determined based on movement of mobile client toward a portion of the mobile network that does not support a multicast session.

6. The method of claim 5, wherein the portion of the mobile network that does not support a multicast session comprises a wireless cell or a sector of a wireless cell.

7. The method of claim 1, wherein the determination that the multicast session to the at least one destination should be switched to a unicast session to the at least one destination is based on a number of destinations of the multicast session.

8. The method of claim 1, wherein the determination that the multicast session to the at least one destination should be switched to a unicast session to the at least one destination is based on net network resource savings if the multicast session were switched to the unicast session.

9. The method of claim 1, further comprising:
determining that the unicast session to the at least one destination should be switched to the multicast session to the plurality of destinations; and
switching the unicast session to the at least one destination to the multicast session to the plurality of destinations.

10. The method of claim 9, wherein the determination that the unicast session to the at least one destination should be switched to the multicast session to the plurality of destinations is based on a quality of service of the multicast session.

11. The method of claim 10, wherein the determination that the unicast session to the at least one destination should be switched to the multicast session to the plurality of destinations comprises:
determining that the quality of service of the multicast session has risen above a threshold.

12. The method of claim 9, wherein switching the unicast session to a multicast session comprises:
initiating the multicast session to the at least one destination before ending the unicast session to the at least one destination;
transmitting data to the at least one destination using both the multicast session and the unicast session; and
ending the unicast session.

13. The method of claim 12, wherein the transmitting of data to the at least one destination using both the multicast session and the unicast session comprises:
combining the data from the multicast session with the data from the unicast session.

14. The method of claim 9, wherein the determination that the unicast session to the at least one destination should be switched to the multicast session to the plurality of destinations is based on an availability of the multicast session.

15. The method of claim 14, wherein the at least one destination is a mobile client, the data is transmitted to the mobile client using a mobile network, and the availability of the multicast session is determined based on movement of mobile client toward a portion of the mobile network that does support a multicast session.

16. The method of claim 15, wherein the portion of the mobile network that does not support a multicast session comprises a wireless cell or a sector of a wireless cell.

17. The method of claim 9, wherein the determination that the unicast session to the at least one destination should be switched to the multicast session to the plurality of destinations is based on a number of destinations of the multicast session.

18. The method of claim 9, wherein the determination that the unicast session to the at least one destination should be switched to the multicast session to the plurality of destinations is based on net network resource savings if the unicast session were switched to the multicast session

19. The method of claim 9, wherein switching the multicast session to a unicast session comprises:
initiating the unicast session to the at least one destination before ending the multicast session to the at least one destination;
transmitting data to the at least one destination using both the multicast session and the unicast session; and
ending the multicast session.

20. The method of claim 19, wherein the transmitting of data to the at least one destination using both the multicast session and the unicast session comprises:
combining the data from the multicast session with the data from the unicast session.

21. The method of claim 9, wherein the plurality of destinations are mobile clients in a mobile network.

22. The method of claim 21, wherein the determination that the unicast session to the at least one destination should be switched to a multicast session to the at least one destination is based on a condition of one mobile network cell.

23. The method of claim 22, wherein the condition of the one mobile network cell comprises at least one of:
a number of mobile clients receiving a particular content using the number of unicast sessions;
an availability of the multicast session in the one mobile network cell; and
a quality of service of the multicast session in the one mobile network cell.

24. The method of claim 22, wherein the determination that the unicast session to the at least one destination should be switched to a multicast session to the at least one destination is based on a condition of a plurality of mobile network cells.

25. The method of claim 24, further comprising:
determining a condition of the plurality of mobile network cells by:
accepting input information relating to a mobile network cell in which the mobile client is located;
accepting input information relating to at least one mobile network cell adjacent to the mobile network cell in which the mobile client is located; and
determining the condition based on the input information.

26. The method of claim 25, wherein the input information relating to at least one mobile network cell adjacent to the mobile network cell in which the mobile client is located comprises at least one of:
an availability of a multicast session in the at least one adjacent mobile network cell;
a number of users of the multicast session in the at least one adjacent mobile network cell;
identities of users of the multicast session in the at least one adjacent mobile network cell;
a quality of service of the multicast session in the at least one adjacent mobile network cell;
security factors associated with the multicast session in the at least one adjacent mobile network cell;
business factors associated with the multicast session in the at least one adjacent mobile network cell;
geographic factors associated with the multicast session in the at least one adjacent mobile network cell;
an ability to receive data from the multicast session in the at least one adjacent mobile network cell; and
an effect on the at least one adjacent mobile network cell of a multicast session being created in the at least one adjacent mobile network cell.

27. The method of claim 26, wherein the business factors associated with the multicast session in the at least one adjacent mobile network cell comprise at least one of:
a pre-defined content distribution territory; and
a level of subscription of a user;

28. The method of claim 26, wherein the number of users of the multicast session in the at least one adjacent mobile network cell is determined by tracking users the number of users in the at least one adjacent mobile network cell as the users join and leave the at least one adjacent mobile network cell or join and leave the multicast session in the at least one adjacent mobile network cell.

29. The method of claim 1, wherein the plurality of destinations are mobile clients in a mobile network.

30. The method of claim 29, wherein the determination that the multicast session to the at least one destination should be switched to a unicast session to the at least one destination is based on a condition of one mobile network cell.

31. The method of claim 30, wherein the condition of the one mobile network cell comprises at least one of:
a number of mobile clients receiving a particular content using the number of unicast sessions;
an availability of the multicast session in the one mobile network cell; and
a quality of service of the multicast session in the one mobile network cell.

32. The method of claim 30, wherein the determination that the multicast session to the at least one destination should be switched to a unicast session to the at least one destination is based on a condition of a plurality of mobile network cells.

33. The method of claim 32, further comprising:
determining a condition of the plurality of mobile network cells by:
accepting input information relating to a mobile network cell in which the mobile client is located;
accepting input information relating to at least one mobile network cell adjacent to the mobile network cell in which the mobile client is located; and
determining the condition based on the input information.

34. The method of claim 33, wherein the input information relating to at least one mobile network cell adjacent to the mobile network cell in which the mobile client is located comprises at least one of:
an availability of a multicast session in the at least one adjacent mobile network cell;
a number of users of the multicast session in the at least one adjacent mobile network cell;
identities of users of the multicast session in the at least one adjacent mobile network cell;
a quality of service of the multicast session in the at least one adjacent mobile network cell;
security factors associated with the multicast session in the at least one adjacent mobile network cell;
business factors associated with the multicast session in the at least one adjacent mobile network cell;
geographic factors associated with the multicast session in the at least one adjacent mobile network cell;
an ability to receive data from the multicast session in the at least one adjacent mobile network cell; and
an effect on the at least one adjacent mobile network cell of a multicast session being created in the at least one adjacent mobile network cell.

35. The method of claim 34, wherein the business factors associated with the multicast session in the at least one adjacent mobile network cell comprise at least one of:
a pre-defined content distribution territory; and
a level of subscription of a user;

36. The method of claim 34, wherein the number of users of the multicast session in the at least one adjacent mobile network cell is determined by tracking users the number of users in the at least one adjacent mobile network cell as the users join and leave the at least one adjacent mobile network cell or join and leave the multicast session in the at least one adjacent mobile network cell.

37. A system for transmitting data traffic comprising:
a processor operable to execute computer program instructions;
a memory operable to store computer program instructions executable by the processor; and
computer program instructions stored in the memory and executable to perform the steps of:
transmitting data using a multicast session to a plurality of destinations;
determining that the multicast session to at least one of the destinations of the plurality of destinations should be switched to a unicast session to the at least one destination; and
switching the multicast session to the at least one destination to a unicast session to the at least one destination.

38. The system of claim 37, wherein the determination that the multicast session to the at least one destination should be switched to a unicast session to the at least one destination is based on a quality of service of the multicast session.

39. The system of claim 38, wherein the determination that the multicast session to the at least one destination should be switched to a unicast session to the at least one destination comprises:
determining that the quality of service of the multicast session to the at least one destination has fallen below a threshold.

40. The system of claim 37, wherein the determination that the multicast session to the at least one destination should be switched to a unicast session to the at least one destination is based on an availability of the multicast session.

41. The system of claim 37, wherein the determination that the multicast session to the at least one destination should be switched to a unicast session to the at least one destination is based on a number of destinations of the multicast session.

42. The system of claim 37, wherein the determination that the multicast session to the at least one destination should be switched to a unicast session to the at least one destination is based on net network resource savings if the multicast session were switched to the unicast session.

43. The system of claim 37, further comprising:
determining that the unicast session to the at least one destination should be switched to the multicast session to the plurality of destinations; and
switching the unicast session to the at least one destination to the multicast session to the plurality of destinations.

44. The system of claim 43, wherein the determination that the unicast session to the at least one destination should be switched to the multicast session to the plurality of destinations is based on a quality of service of the multicast session.

45. The system of claim 44, wherein the determination that the unicast session to the at least one destination should be switched to the multicast session to the plurality of destinations comprises:
determining that the quality of service of the multicast session has risen above a threshold.

46. The system of claim 43, wherein switching the unicast session to a multicast session comprises:
initiating the multicast session to the at least one destination before ending the unicast session to the at least one destination;
transmitting data to the at least one destination using both the multicast session and the unicast session; and
ending the unicast session.

47. The system of claim 46, wherein the transmitting of data to the at least one destination using both the multicast session and the unicast session comprises:
combining the data from the multicast session with the data from the unicast session.

48. The system of claim 47, wherein the determination that the unicast session to the at least one destination should be switched to the multicast session to the plurality of destinations is based on an availability of the multicast session.

49. The system of claim 47, wherein the determination that the unicast session to the at least one destination should be switched to the multicast session to the plurality of destinations is based on a number of destinations of the multicast session.

50. The system of claim 47, wherein the determination that the unicast session to the at least one destination should be switched to the multicast session to the plurality of destinations is based on net network resource savings if the unicast session were switched to the multicast session

51. The system of claim 47, wherein switching the multicast session to a unicast session comprises:
initiating the unicast session to the at least one destination before ending the multicast session to the at least one destination;
transmitting data to the at least one destination using both the multicast session and the unicast session; and
ending the multicast session.

52. The system of claim 51, wherein the transmitting of data to the at least one destination using both the multicast session and the unicast session comprises:
combining the data from the multicast session with the data from the unicast session.

53. A system for transmitting data traffic from a data source to a client application comprising:
a server adapter operable to receive data from the data source in a unicast session and transmit the data in a unicast session or in a multicast session, and operable to receive data from the data source in a multicast session and transmit the data in at least one unicast session or in a multicast session; and
a client adapter operable to receive data from the server adapter in a unicast session or a multicast session and transmit the data to the client application.

54. A system of claim 53, wherein the server adapter is further operable to switch between transmitting the data in a unicast session or in a multicast session.

55. The system of claim 53, wherein the server adapter is further operable to determine that the multicast session should be switched to at least one unicast session and to switch the multicast session to the at least one unicast session.

56. The system of claim 55, wherein the server adapter is further operable to determine that the multicast session should be switched to at least one unicast session based on a quality of service of the multicast session.

57. The system of claim 56, wherein the server adapter is further operable to determine that the multicast session should be switched to at least one unicast session by determining that the quality of service of the multicast session to the at least one destination has fallen below a threshold.

58. The system of claim 55, wherein the server adapter is further operable to determine that the multicast session should be switched to at least one unicast session based on an availability of the multicast session.

59. The system of claim 55, wherein the server adapter is further operable to determine that the multicast session should be switched to at least one unicast session based on a number of destinations of the multicast session.

60. The system of claim 55, wherein the server adapter is further operable to determine that the multicast session should be switched to at least one unicast session based on net network resource savings if the multicast session were switched to the unicast session.

61. The system of claim 54, wherein the server adapter is further operable to determine that the at least one unicast session should be switched to a multicast session and to switch the at least one unicast session to a multicast session.

62. The system of claim 61, wherein the server adapter is further operable to determine that the at least one unicast session should be switched to a multicast session based on a quality of service of the multicast session.

63. The system of claim 62, wherein the server adapter is further operable to determine that the at least one unicast session should be switched to a multicast session by determining that the quality of service of the multicast session to the at least one destination has fallen below a threshold.

64. The system of claim 63, wherein the server adapter is further operable to determine that the at least one unicast session should be switched to a multicast session based on an availability of the multicast session.

65. The system of claim 61, wherein the server adapter is further operable to determine that the at least one unicast session should be switched to a multicast session based on a number of destinations of the multicast session.

66. The system of claim 61, wherein the server adapter is further operable to determine that the at least one unicast session should be switched to a multicast session based on net network resource savings if the unicast session were switched to the multicast session.

67. The system of claim 56, wherein the server adapter is further operable to switch the multicast session to a unicast session by initiating the unicast session before ending the multicast session, transmitting data using both the multicast session and the unicast session, and ending the multicast session.

68. The system of claim 67, wherein the client adapter is further operable to receive data from the server adapter in both a unicast session and a multicast session and transmit the data to the client application.

69. The system of claim 68, wherein the client adapter is further operable to receive data from the server adapter in both a unicast session and a multicast session by combining the data from the multicast session with the data from the unicast session.

70. The system of claim 54, wherein the server adapter is further operable to switch the unicast session to a multicast session by initiating the multicast session before ending the unicast session, transmitting data using both the multicast session and the unicast session, ending the unicast session.

71. The system of claim 70, wherein the client adapter is further operable to receive data from the server adapter in both a unicast session and a multicast session and transmit the data to the client application.

72. The system of claim 67, wherein the client adapter is further operable to receive data from the server adapter in both a unicast session and a multicast session by combining the data from the multicast session with the data from the unicast session.

73. A method of transmitting data traffic comprising:
at a server:
receiving data from a data source,
transmitting the data in a unicast session or in a multicast session to a client, and
switching the unicast session to a multicast session or the multicast session to a unicast session, based on a determination by the server or by the client that the session should be switched; and
at the client:
receiving data from the server in a unicast session or in a multicast session, and
switching the unicast session to a multicast session or the multicast session to a unicast session, based on a determination by the server or by the client that the session should be switched.

74. The method of claim 73, further comprising:
determining at the server that the unicast session should be switched to a multicast session or the multicast session should be switched to a unicast session based on a number of destinations of the multicast session.

75. The method of claim 74, further comprising:
if a unicast session exists:
at the server, instructing the client to terminate the unicast session and to initiate a multicast session, and
at the client, receiving the instruction from the server and terminating the unicast session and initiating the multicast session; and
if a multicast session exists:
at the server, instructing the client to terminate the multicast session and to initiate a unicast session, and
at the client, receiving the instruction from the server and terminating the multicast session and initiating the unicast session.

76. The method of claim 73, further comprising:
determining at the server that the unicast session should be switched to a multicast session or the multicast session should be switched to a unicast session based on net network resource savings if the session were switched.

77. The method of claim 76, further comprising:
if a unicast session exists:
at the server, instructing the client to terminate the unicast session and to initiate a multicast session, and
at the client, receiving the instruction from the server and terminating the unicast session and initiating the multicast session; and
if a multicast session exists:
at the server, instructing the client to terminate the multicast session and to initiate a unicast session, and
at the client, receiving the instruction from the server and terminating the multicast session and initiating the unicast session.

78. The method of claim 73, further comprising:
determining at the client that the unicast session should be switched to a multicast session or the multicast session should be switched to a unicast session based on a quality of service of the multicast session.

79. The method of claim 78, further comprising:
if a unicast session exists:
at the client, instructing the server to terminate the unicast session and to initiate a multicast session, and
at the server, receiving the instruction from the client and terminating the unicast session and initiating the multicast session; and
if a multicast session exists:
at the client, instructing the server to terminate the multicast session and to initiate a unicast session, and
at the server, receiving the instruction from the client and terminating the multicast session and initiating the unicast session.

80. The method of claim 73, further comprising:
determining at the client that the unicast session should be switched to a multicast session or the multicast session should be switched to a unicast session by determining that the quality of service of the multicast session has fallen below a threshold.

81. The method of claim 80, further comprising:
if a unicast session exists:
at the client, instructing the server to terminate the unicast session and to initiate a multicast session, and
at the server, receiving the instruction from the client and terminating the unicast session and initiating the multicast session; and
if a multicast session exists:
at the client, instructing the server to terminate the multicast session and to initiate a unicast session, and
at the server, receiving the instruction from the client and terminating the multicast session and initiating the unicast session.

82. The method of claim 81, wherein the determination that the multicast session to the at least one destination should be switched to a unicast session to the at least one destination is based on an availability of the multicast session.

83. A method of receiving data traffic comprising:
receiving data at a mobile client using a multicast session;
detecting that data transmission to the mobile client is to be handed off to a portion of a mobile network that does not support a multicast session;
initiating a unicast session in the portion of the mobile network that does not support a multicast session; and
receiving the data using the unicast session in the portion of the mobile network that does not support a multicast session.

84. The method of claim 83, wherein the detecting that data transmission to the mobile client is to be handed off to the portion of the mobile network that does not support a multicast session comprises:
detecting that data transmission to the mobile client is to be handed off to the portion of the mobile network not currently providing data transmission to the mobile client;
attempting to join the mobile client in a multicast session in the portion of the mobile network not currently providing data transmission to the mobile client; and
detecting that the mobile client cannot join in a multicast session in the portion of the mobile network not currently providing data transmission to the mobile client.

85. The method of claim 84, further comprising:
after initiating a unicast session in the portion of the mobile network that does not support a multicast session, detecting that data can be received using the initiated unicast session; and
terminating the multicast session.

86. The method of claim 84, further comprising:
after initiating a unicast session in the portion of the mobile network that does not support a multicast session, detecting that data can be received using the initiated unicast session;
receiving data using both the multicast session and the unicast session; and
terminating the multicast session.

87. The method of claim 84, wherein the portion of the mobile network that does not support a multicast session comprises a wireless cell or a sector of a wireless cell and the portion of the mobile network that does support a multicast session comprises a wireless cell or a sector of a wireless cell.

88. The method of claim 83, further comprising:
detecting that data transmission to the mobile client is to be handed off to a portion of a mobile network that does support a multicast session;
initiating a multicast session in the portion of the mobile network that does support a multicast session; and
receiving the data using the multicast session in the portion of the mobile network that does support a multicast session.

89. The method of claim 88, wherein the detecting that data transmission to the mobile client is to be handed off to a portion of a mobile network that does support a multicast session comprises:
detecting that data transmission to the mobile client is to be handed off to the portion of the mobile network not currently providing data transmission to the mobile client;
attempting to join the mobile client in a multicast session in the portion of the mobile network not currently providing data transmission to the mobile client; and
detecting that the mobile client can join in a multicast session in the portion of the mobile network not currently providing data transmission to the mobile client.

90. The method of claim 89, further comprising:
after initiating a multicast session in the portion of the mobile network that does support a multicast session, detecting that data can be received using the initiated multicast session; and
terminating the unicast session.

91. The method of claim 89, further comprising:
after initiating a multicast session in the portion of the mobile network that does support a multicast session, detecting that data can be received using the initiated multicast session;
receiving data using both the multicast session and the unicast session; and
terminating the unicast session.

92. The method of claim 91, wherein the portion of the mobile network that does not support a multicast session comprises a wireless cell or a sector of a wireless cell and the portion of the mobile network that does support a multicast session comprises a wireless cell or a sector of a wireless cell.

93. A method of transmitting data comprising:
establishing a multicast session at a mobile client;
establishing a unicast session at the mobile client;
receiving media data using the multicast session at the mobile client; and
receiving control data using the unicast session at the mobile client.

94. The method of claim 93, wherein the received control data comprises an indication that the multicast session will no longer be available and the method further comprises:
receiving media data using the unicast session at the mobile client.

95. The method of claim 93, wherein the received control data comprises an indication that the multicast session will no longer be available and the method further comprises:
receiving media data using both the multicast session and the unicast session at the mobile client; and
receiving media data using only the unicast session at the mobile client.

96. The method of claim 95, further comprising:
receiving an indication that a multicast session is available at the mobile client;
receiving media data using the multicast session at the mobile client; and
receiving control data using the unicast session at the mobile client.

97. The method of claim 95, further comprising:
receiving an indication that a multicast session is available at the mobile client;
receiving media data using both the multicast session and the unicast session at the mobile client; and
receiving media data using only the multicast session at the mobile client; and
receiving control data using the unicast session at the mobile client.
